(19) United States
(12) Patent Application Publication
(10) Pub. No.: US 2026/0299479 A1
(43) Pub. Date: Oct. 1, 2026

(54) IMAGE FORMING APPARATUS, IMAGE FORMING SYSTEM, AND NON-TRANSITORY COMPUTER READABLE MEDIUM STORING IMAGE FORMING PROGRAM

(71) Applicant: FUJIFILM Business Innovation Corp., Tokyo (JP)

(72) Inventor: Yuki ANDO, Kanagawa (JP)

(73) Assignee: FUJIFILM Business Innovation Corp., Tokyo (JP)

(21) Appl. No.: 19/264,830

(22) Filed: Jul. 9, 2025

(30) Foreign Application Priority Data
Mar. 26, 2025 (JP) 2025-051873

(51) Int. Cl. G03G 15/00; G03G 21/20

(52) U.S. Cl. CPC G03G 15/5054; G03G 15/5091; G03G 21/203; G03G 15/5016; G03G 2215/047

(57) ABSTRACT

An image forming apparatus includes an image forming unit that forms an image on a recording medium supplied from a supply portion under a predetermined condition, a correction unit that obtains a correction amount of the condition in accordance with a reading result of the image formed on the recording medium and corrects the condition, and a storage unit that stores the correction amount, in which the storage unit stores the correction amount in association with both of medium information for specifying the recording medium and supply portion information for specifying the supply portion.

### CROSS-REFERENCE TO RELATED APPLICATIONS

This application is based on and claims priority under 35 USC 119 from Japanese Patent Application No. 2025-051873 filed Mar. 26, 2025.

### BACKGROUND

### (i) Technical Field

The invention relates to an image forming apparatus, an image forming system, and a non-transitory computer readable medium storing an image forming program.

### (ii) Related Art

In the related art, for example, techniques disclosed in JP2021-135393A and JP2022-026380A have been suggested as a technique related to an image forming apparatus.

JP2021-135393A discloses a configuration in which an analysis portion, in a case where an image is formed on paper sheets accommodated in a plurality of trays by an image forming portion, calculates an adjustment value for each tray, and a correction portion, in a case where the image is formed on the paper sheets accommodated in the plurality of trays by the image forming portion, performs a predetermined control.

JP2022-026380A discloses a configuration including a unit that, in accordance with occurrence of an event of registering an adjustment value of a printing position in one piece of paper sheet attribute data in which paper sheet size information is not set, acquires paper sheet attribute data that is another paper sheet attribute data created based on the one piece of paper sheet attribute data and in which the adjustment value and one paper sheet size are registered.

### SUMMARY

Aspects of non-limiting embodiments of the present disclosure relate to an image forming apparatus, an image forming system, and a non-transitory computer readable medium storing an image forming program that effectively use a stored correction amount compared to a case where a correction amount for correcting an image forming condition is stored in association with only any one of medium information for specifying a recording medium or supply portion information for specifying a supply portion.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including an image forming unit that forms an image on a recording medium supplied from a supply portion under a predetermined condition, a correction unit that obtains a correction amount of the condition in accordance with a reading result of the image formed on the recording medium and corrects the condition, and a storage unit that stores the correction amount, in which the storage unit stores the correction amount in association with both of medium information for specifying the recording medium and supply portion information for specifying the supply portion.

### BRIEF DESCRIPTION OF THE DRAWINGS

Exemplary embodiment(s) of the present invention will be described in detail based on the following figures, wherein:

FIG. 1 is a schematic diagram illustrating an overall configuration of an image forming apparatus to which an image forming program and an image forming system according to Exemplary Embodiment 1 of the invention are applied;

FIG. 2 is a schematic diagram illustrating the overall configuration of the image forming apparatus to which the image forming program and the image forming system according to Exemplary Embodiment 1 of the invention are applied;

FIG. 3 is a configuration diagram illustrating an image forming portion of the image forming apparatus to which the image forming program and the image forming system according to Exemplary Embodiment 1 of the invention are applied;

FIGS. 4A to 4L are schematic diagrams each illustrating post-processing performed by a post-processing portion of the image forming apparatus to which the image forming program and the image forming system according to Exemplary Embodiment 1 of the invention are applied;

FIG. 5 is a block diagram illustrating a control device of the image forming apparatus to which the image forming program and the image forming system according to Exemplary Embodiment 1 of the invention are applied;

FIG. 6 is a plan configuration view illustrating a recording paper sheet on which a test image is formed;

FIGS. 7A to 7D are descriptive diagrams illustrating the test image in an enlarged manner;

FIG. 8 is a descriptive diagram illustrating arrangement of recording paper sheets on which an image is formed by the image forming apparatus to which the image forming program and the image forming system according to Exemplary Embodiment 1 of the invention are applied;

FIGS. 9A to 9F are descriptive diagrams each illustrating misregistration and size deviation of the image;

FIGS. 10A and 10B are descriptive diagrams each illustrating the misregistration of the image;

FIG. 11 is a table illustrating an amount of the misregistration of the image;

FIG. 12 is a schematic diagram illustrating a state of use of correction amount data in an image forming apparatus of the related art;

FIG. 13 is a schematic diagram illustrating the state of use of the correction amount data in the image forming apparatus in the related art;

FIG. 14 is a schematic diagram illustrating a state of use of correction amount data in the image forming apparatus to which the image forming program according to Exemplary Embodiment 1 of the invention is applied;

FIG. 15 is a configuration diagram illustrating a setting screen on a UI portion;

FIG. 16 is a descriptive diagram illustrating the setting screen of the UI portion;

FIG. 17 is a flowchart illustrating an operation of the image forming apparatus to which the image forming program and the image forming system according to Exemplary Embodiment 1 of the invention are applied;

FIG. 18 is a schematic diagram illustrating an image forming apparatus to which an image forming program and an image forming system according to Exemplary Embodiment 2 of the invention are applied;

FIG. 19 is a block diagram illustrating a control device of the image forming apparatus to which the image forming program and the image forming system according to Exemplary Embodiment 2 of the invention are applied;

FIG. 20 is a descriptive diagram illustrating an image with high coverage and an image with low coverage formed on the recording paper sheet;

FIGS. 21A and 21B are graphs illustrating a measuring result of the misregistration of the image;

FIG. 22 is a descriptive diagram illustrating the setting screen of the UI portion; and

FIG. 23 is a flowchart illustrating an operation of an image forming apparatus to which an image forming program and an image forming system according to a modification example of Exemplary Embodiment 2 of the invention are applied.

### DETAILED DESCRIPTION

Hereinafter, exemplary embodiments of the invention will be described with reference to the drawings.

### Exemplary Embodiment 1

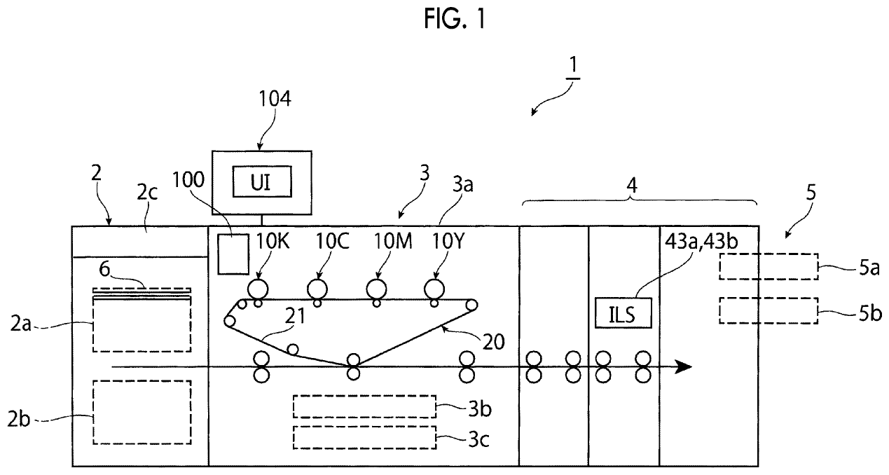

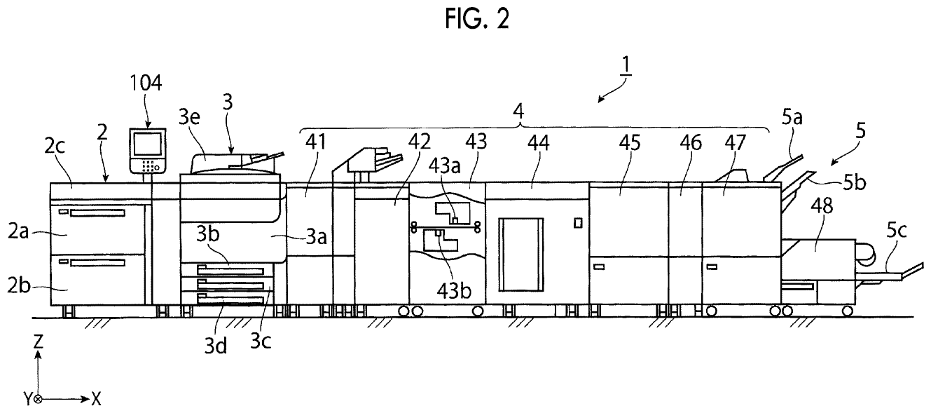

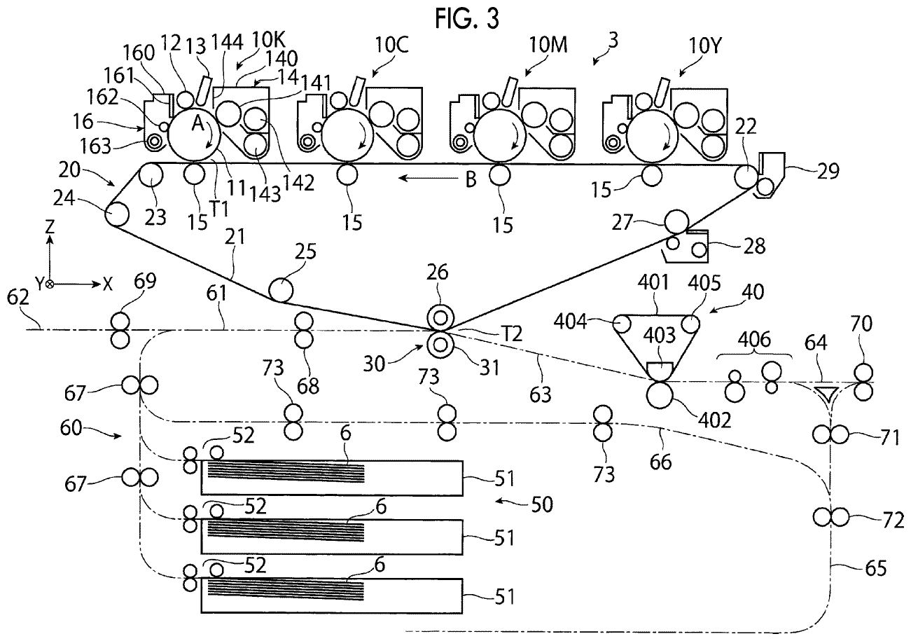

FIG. 1 is a schematic diagram illustrating an overall configuration of an image forming apparatus to which an image forming program and an image forming system according to Exemplary Embodiment 1 are applied. FIG. 2 is a schematic diagram illustrating the overall configuration of the image forming apparatus to which the image forming program and the image forming system according to Exemplary Embodiment 1 are applied. FIG. 3 is a configuration diagram illustrating an image forming portion of the image forming apparatus to which the image forming program and the image forming system according to Exemplary Embodiment 1 are applied. In FIG. 2, arrow X indicates a horizontal direction of the image forming apparatus, arrow Y indicates a depth direction of the image forming apparatus, and arrow Z indicates a vertical direction of the image forming apparatus.

### Overall Configuration of Image Forming Apparatus

An image forming apparatus 1 is configured as, for example, a full color production printer. As illustrated in FIG. 1, the image forming apparatus 1 broadly includes a paper feed portion 2, an image forming portion 3, a post-processing portion 4, and a discharge portion 5. The image forming apparatus 1 does not necessarily include all of the paper feed portion 2, the post-processing portion 4, the discharge portion 5, and the like. For example, the image forming apparatus 1 may not include the post-processing portion 4, and the paper feed portion 2, the image forming portion 3, and the like may be disposed in an apparatus body 3a constituting the image forming portion 3.

The paper feed portion 2 of the image forming apparatus 1 is configured with, for example, two high capacity trays 2a and 2b that include an air suction mechanism, a multifeed detection device, and the like and that are disposed above and below each other, and a manual paper feed tray 2c disposed above the high capacity tray 2a. The paper feed portion 2 is not limited to the feed portion including the air suction mechanism, the multifeed detection device, and the like.

The image forming portion 3 of the image forming apparatus 1 forms an image such as a full color or monochrome image on one side or two sides of a recording paper sheet 6 as an example of a recording medium supplied from the paper feed portion 2. The image forming apparatus 1 according to Exemplary Embodiment 1 includes a single or a plurality of paper feed trays 3b, 3c, . . . in the image forming portion 3.

The post-processing portion 4 performs required post-processing such as bending correction processing, inspection (reading) processing of the image, stack processing, binding processing, folding processing, and perforation processing on the recording paper sheet 6 on which the image is formed on one side or two sides by the image forming portion 3.

The discharge portion 5 discharges the recording paper sheet 6 on which the required post-processing is performed by the post-processing portion 4 to a single or a plurality of discharge trays 5a, 5b, . . . . A fixed tray, a stack tray, a booklet tray, or the like is used as the discharge trays 5a, 5b, . . . . The fixed tray is fixedly disposed. The stack tray discharges the recording paper sheet 6 by moving along a top-to-bottom direction that is the vertical direction Z, or a front-to-rear direction that is the depth direction Y, as necessary. The booklet tray discharges a booklet consisting of a plurality of recording paper sheets 6 on which the binding processing is performed, by moving along the horizontal direction.

To further describe the configuration of the image forming apparatus 1 as the production printer, as illustrated in FIG. 2, the image forming apparatus 1 includes the paper feed portion 2 on an upstream side (in the drawing, a left side) along a transport direction of the recording paper sheet 6 with reference to the image forming portion 3. The image forming apparatus 1 includes the post-processing portion 4 and the discharge portion 5 on a downstream side (in the drawing, a right side) along the transport direction of the recording paper sheet 6 of the image forming portion 3. The post-processing portion 4 is configured with, for example, a bending correction device 41, a paper sheet insertion device 42, an image inspection device 43, a high capacity stacker 44, a head and tail cutting device 45, a folding device 46, a binding device 47 having a punch and discharge function, and a fore edge cutting device 48 having a square back folding function. The discharge portion 5 is configured with the fixed tray 5a and the stack tray 5b as a discharge tray mounted in the binding device 47, and a booklet tray 5c mounted in the fore edge cutting device 48.

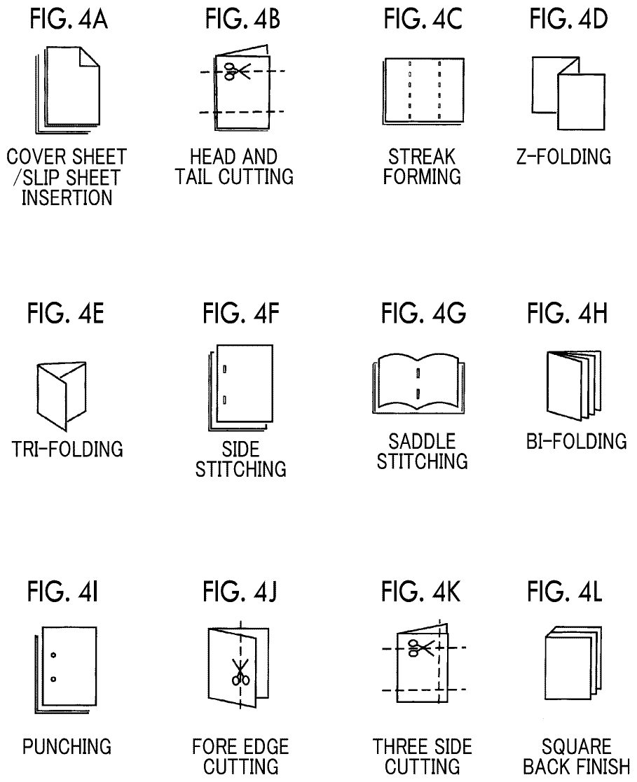

The bending correction device 41 corrects bending of the recording paper sheet 6 discharged from the image forming portion 3. The paper sheet insertion device 42, as illustrated in FIG. 4A, inserts a cover sheet, a slip sheet, or the like at a predetermined position in a plurality of recording paper sheets 6 continuously discharged from the image forming portion 3. The image inspection device 43 inspects a printed matter by reading the image including a test image formed on a front side and a rear side of the recording paper sheet 6 via first and second in line sensors (ILSs) 43a and 43b as an example of a reading unit (an image sensor). The first and second ILSs 43a and 43b can read the image with a predetermined resolution and color (brightness, chroma, and hue). The high capacity stacker 44 connects the image inspection device 43 to the head and tail cutting device 45 on the subsequent stage and adjusts a processing speed by sequentially stacking a large number of recording paper sheets 6. The head and tail cutting device 45, as illustrated in FIG. 4B, cuts an upper side and a lower side (a head and a tail) of the recording paper sheet 6 over a required width. The head and tail cutting device 45, as illustrated in FIG. 4C, also executes, for example, processing of forming streaks on the recording paper sheet 6. The folding device 46, as illustrated in FIGS. 4D and 4E, performs the folding processing such as Z-folding or tri-folding on the recording paper sheet 6. The binding device 47 sorts and stacks the recording paper sheet 6 after passing through the folding device 46 and, as illustrated in FIGS. 4F to 4I, performs bi-folding or perforation processing in addition to the binding processing such as side stitching or saddle stitching. The recording paper sheet 6 on which the binding processing such as edge stitching or saddle stitching, perforation processing, or the like is performed is discharged to the fixed tray 5a or the stack tray 5b of the discharge portion 5 in accordance with content or the like of the post-processing. The fore edge cutting device 48, as illustrated in FIGS. 4J to 4L, performs fore edge cutting processing and three side cutting processing of cutting upper and lower edges and another one edge of the recording paper sheet 6 on which the saddle stitching processing or the like is performed, and further performs square back finish processing or the like. The recording paper sheet 6 on which the fore edge cutting processing or the like is performed is sequentially discharged to the booklet tray 5c disposed in the horizontal direction.

Next, a configuration of the image forming portion 3 of the image forming apparatus 1 will be described.

As illustrated in FIG. 3, the image forming portion 3 of the image forming apparatus 1 broadly includes a plurality of image creating devices 10, an intermediate transfer device 20, a paper feed device 50, a paper sheet transport device 60, a fixing device 40, and the like. In the illustrated exemplary embodiment, the image forming portion 3, as illustrated in FIG. 2, includes an image reading device 3e that reads an image of an original document, at an upper end of the image forming portion 3.

The plurality of image creating devices 10, as illustrated in FIG. 3, form a toner image (a color material image) developed with toner as an example of a color material constituting a developer. The intermediate transfer device 20 holds and transports each toner image formed by each image creating device 10 to a secondary transfer position T2 at which the toner image is finally transferred to the recording paper sheet 6. The paper feed device 50 accommodates and supplies the required recording paper sheet 6 to be transported to the secondary transfer position T2 of the intermediate transfer device 20. The paper sheet transport device 60 transports the recording paper sheet 6 through the secondary transfer position T2 of the intermediate transfer device 20. The fixing device 40 fixes the toner image secondarily transferred by the intermediate transfer device 20 on the recording paper sheet 6.

The plurality of image creating devices 10 and the intermediate transfer device 20 are examples of an image forming unit that forms an image on the recording paper sheet 6 under a predetermined condition. Here, the predetermined condition indicates that an image is formed with a predetermined size at a predetermined position of the recording paper sheet 6 and misregistration or size deviation of the image falls within an allowable range, and an image is formed on the recording paper sheet 6 with predetermined density (including tone) and density deviation falls within an allowable range. In a case where the image formed on the recording paper sheet 6 is a text image or a line image, the predetermined condition only indicates that the image is formed with the predetermined size at the predetermined position of the recording paper sheet 6 and the misregistration or the size deviation falls within the allowable range.

The image creating devices 10 are configured with four image creating devices 10Y, 10M, 10C, and 10K that are dedicated to forming toner images of four colors including yellow (Y), magenta (M), cyan (C), and black (K), respectively. The four image creating devices 10 (Y, M, C, and K) are disposed at required intervals along a periphery of an intermediate transfer belt 21 in an internal space of the apparatus body 3a (see FIG. 1) of the image forming portion 3.

Each image creating device 10 (Y, M, C, and K), as illustrated in FIG. 3, includes a photoreceptor drum 11 that is an example of an image holding unit that rotates. A toner image forming unit described below is generally disposed on a periphery of the photoreceptor drum 11. The toner image forming unit includes a charging device 12, an exposure device 13, a developing device 14, a primary transfer device 15, a drum cleaning device 16, and the like. The charging device 12 charges a peripheral surface (an image holding surface) of the photoreceptor drum 11 on which an image can be formed, to a required potential. The exposure device 13 forms electrostatic latent images with a difference in potential (for each color) by irradiating the charged peripheral surface of the photoreceptor drum 11 with light based on information (a signal) about the image. The developing device 14 forms the toner images by developing the electrostatic latent images with the toner of the developer of corresponding colors (Y, M, C, and K). The primary transfer device 15 transfers each toner image to the intermediate transfer device 20. The drum cleaning device 16 performs cleaning by removing an adhering substance such as the toner that remains adhering to the image holding surface of the photoreceptor drum 11 after primary transfer.

The photoreceptor drum 11 is obtained by forming the image holding surface including a photoconductive layer (a photoreceptive layer) consisting of a photoreceptive material on a peripheral surface of a cylindrical or columnar base material that is processed to be grounded. The photoreceptor drum 11 is supported to rotate in a direction indicated by arrow A by transmitting driving force from a driving device (not illustrated) to the photoreceptor drum 11.

The charging device 12 is configured with a contact type charging roll disposed in a state of being in contact with the photoreceptor drum 11. The charging device 12 is supplied with a charging voltage. In a case where the developing device 14 performs reversal developing, a voltage or a current having the same polarity as a charging polarity of the toner supplied from the developing device 14 is supplied as the charging voltage. A non-contact type charging device such as a scorotron disposed in a non-contact state with the photoreceptor drum 11 may also be used as the charging device 12.

The exposure device 13 consists of an LED printhead that forms the electrostatic latent image configured in accordance with the information on the image input into the image forming apparatus 1 by irradiating the photoreceptor drum 11 with light via LEDs as a plurality of light emitting elements arranged along an axial direction of the photoreceptor drum 11. When the latent image is formed, the information (the signal) on the image input into the image forming apparatus 1 by any unit is transmitted to the exposure device 13. An exposure device that forms the electrostatic latent images by irradiating the peripheral surface of the charged photoreceptor drum 11 with laser light configured in accordance with the information on the image input into the image forming apparatus 1 may be used as the exposure device 13.

Each developing device 14 is configured by disposing a developing roll 141, agitating and transport members 142 and 143, a layer thickness regulating member 144, and the like in a housing 140 in which an opening portion and an accommodating chamber for the developer are formed. The developing roll 141 holds the developer in the housing 140 and transports the developer to a developing region facing the photoreceptor drum 11. The agitating and transport members 142 and 143 consist of a screw auger or the like that transports the developer through the developing roll 141 while agitating the developer. The layer thickness regulating member 144 regulates an amount (a layer thickness) of the developer to be held on the developing roll 141. The developing device 14 is supplied with a developing bias voltage from a power supply device (not illustrated) between the developing roll 141 and the photoreceptor drum 11. The developing roll 141 and the agitating and transport members 142 and 143 rotate in a required direction by transmitting driving force from a driving device (not illustrated) to the developing roll 141 and the agitating and transport members 142 and 143. Two-component developers including non-magnetic toner and a magnetic carrier are used as the above developers of four colors (Y, M, C, and K). The developing device 14 is supplied with toner of corresponding colors from a toner cartridge (not illustrated) at a required timing, and toner density in the housing 140 is adjusted.

The primary transfer device 15 is a contact type transfer device including a primary transfer roll that comes into contact with the peripheral surface of the photoreceptor drum 11 and rotates at a primary transfer position T1 with the intermediate transfer belt 21 interposed between the primary transfer device 15 and the photoreceptor drum 11 and that is supplied with a primary transfer voltage. A direct current voltage having a polarity opposite to the charging polarity of the toner is supplied from a power supply device (not illustrated) as the primary transfer voltage.

The drum cleaning device 16 is configured with a cleaning blade 161 and a cleaning brush 162 disposed in a body 160 having a container shape, a feed member 163, and the like. The cleaning blade 161 and the cleaning brush 162 perform cleaning by removing the adhering substance on the photoreceptor drum 11. The feed member 163 collects the adhering substance such as the toner removed by the cleaning blade 161 and the cleaning brush 162 and transports the adhering substance to be fed to a collection system (not illustrated).

The intermediate transfer device 20, as illustrated in FIG. 3, is disposed to be present below the image creating devices 10 (Y, M, C, and K) along the vertical direction Z. The intermediate transfer device 20 is generally configured with the intermediate transfer belt 21, a plurality of belt support rolls 22 to 27, a secondary transfer device 30, and two belt cleaning devices 28 and 29. The intermediate transfer belt 21 is an example of an intermediate transfer medium that circulates in a direction indicated by arrow B while passing through the primary transfer position T1 between the photoreceptor drum 11 and the primary transfer device 15 (the primary transfer roll). The plurality of belt support rolls 22 to 27 support the intermediate transfer belt 21 such that the intermediate transfer belt 21 is held in a favorable state from an inner periphery of the intermediate transfer belt 21 and can move in circulation. The secondary transfer device 30 is disposed on an outer peripheral surface (the image holding surface) side of the intermediate transfer belt 21 supported by the belt support roll 26 and secondarily transfers the toner image on the intermediate transfer belt 21 to the recording paper sheet 6. The belt cleaning devices 28 and 29 perform cleaning by removing the adhering substance such as the toner, paper dust, or the like that remains adhering to the outer peripheral surface of the intermediate transfer belt 21 after passing through the secondary transfer device 30.

For example, an endless belt made of a material obtained by dispersing a resistance adjusting agent such as carbon black in a synthetic resin such as a polyimide resin or a polyamide resin is used as the intermediate transfer belt 21. The belt support roll 22 is configured as a driving roll and also as a support roll of the belt cleaning device 29. The belt support roll 23 is configured as a leveling roll that holds a traveling position of the intermediate transfer belt 21. The belt support roll 24 is configured as a tension applying roll that applies tension to the intermediate transfer belt 21. The belt support roll 25 is configured as a driven roll that holds the traveling position of the intermediate transfer belt 21. The belt support roll 26 is configured as a backup roll of the secondary transfer device 30. The belt support roll 27 is configured as a support roll of the belt cleaning device 28.

The secondary transfer device 30, as illustrated in FIG. 3, includes a secondary transfer roll 31 that rotates at the secondary transfer position T2 that is an outer peripheral surface part of the intermediate transfer belt 21 supported by the belt support roll 26 in the intermediate transfer device 20. The secondary transfer roll 31 or the belt support roll 26 of the intermediate transfer device 20 is supplied with a direct current voltage having the opposite polarity or the same polarity as the charging polarity of the toner as a secondary transfer voltage.

The fixing device 40 is configured by disposing a heating rotor 401 in a belt form or a roll form and a pressing rotor 402 in a roll form or a belt form that is driven to rotate in contact with the heating rotor 401 at a predetermined pressure in a state of being substantially parallel to an axial direction of the heating rotor 401, in a housing (not illustrated) in which an introduction port and a discharge port of the recording paper sheet 6 are formed. The heating rotor 401 in the belt form is rotatably stretched between a heating member 403 in a pad form or a roll form and stretching rolls 404 and 405 also serving as heating units. In the fixing device 40, a contact portion in which the heating rotor 401 and the pressing rotor 402 are in contact with each other is a fixing processing portion that performs required fixing processing (heating and pressing).

A cooling device (not illustrated) that cools the recording paper sheet 6, a bending correction device 406, and the like may be disposed on a downstream side of the fixing device 40.

The paper feed device 50, as illustrated in FIG. 3, is disposed to be present at a position below the intermediate transfer device 20 in the vertical direction Z. The paper feed device 50 is generally configured with a paper sheet accommodator 51 constituting the plurality of (or single) paper feed trays 3b, 3c, and 3d, and a feed device 52. The paper sheet accommodator 51 accommodates the recording paper sheet 6 having a required size, material, and the like in a state where the recording paper sheet 6 is stacked. The feed device 52 feeds the recording paper sheet 6 one sheet at a time from the paper sheet accommodator 51. The paper feed trays 3b, 3c, and 3d consisting of the paper sheet accommodator 51, as illustrated in FIG. 2, are attached such that the paper feed trays 3b, 3c, and 3d can be pulled out to, for example, a front surface (a side surface that a user faces when performing an operation) side of the apparatus body 3a.

Examples of the recording paper sheet 6 include plain paper used in a copy machine or a printer of an electrophotographic system, thin paper such as tracing paper, and an OHP sheet consisting of a transparent film-shaped medium made of a synthetic resin (PET or the like). In order to further improve smoothness of an image surface after fixing, for example, the front side of the recording paper sheet 6 is as smooth as possible. For example, coated paper obtained by coating a front side of the plain paper with a rein or the like, or so-called thick paper having a relatively large paper weight, such as art paper for printing, can be appropriately used.

While the recording paper sheet 6 may have any size, not only a regular size such as A4 size (210×297 mm) or A3 size (297×420 mm) but also A4 extended size or A3 extended size slightly larger than A4 size or A3 size are used.

The paper sheet transport device 60 broadly includes a first paper feed transport path 61, a second paper feed transport path 62, an intermediate transport path 63, a discharge transport path 64, a reversal transport path 65, a two-sided transport path 66, and the like. The first paper feed transport path 61 is configured with a plurality of (or single) paper sheet transport roll pairs 67 and 68 that transport the recording paper sheet 6 fed from the paper sheet accommodator 51 of the paper feed device 50 to the secondary transfer position T2 of the intermediate transfer device 20, and a transport guide (not illustrated). The second paper feed transport path 62 is configured with a single (or a plurality of) paper sheet transport roll pair 69 that transports the recording paper sheet 6 supplied from the external paper feed portion 2 to join the first paper feed transport path 61, and a transport guide (not illustrated). The intermediate transport path 63 is configured with a transport belt (not illustrated) and the like that transport the recording paper sheet 6 on which the toner image is transferred at the secondary transfer position T2 of the intermediate transfer device 20, to the fixing device 40. The discharge transport path 64 is configured with a single (or a plurality of) discharge roll pair 70 that discharges the recording paper sheet 6 on which the toner image is fixed by the fixing device 40, to the outside of the image forming portion 3, and a transport guide (not illustrated). The reversal transport path 65 is configured with a transport roll pair 71 that transports the recording paper sheet 6 on which the image is formed on one side by switching the transport direction of the recording paper sheet 6 downward, a reversal roll pair 72 that reverses the front and the rear of the recording paper sheet 6, and a transport guide (not illustrated). The two-sided transport path 66 is configured with a plurality of (or single) paper sheet transport roll pairs 73 that transport the recording paper sheet 6 of which the front and the rear are reversed by the reversal transport path 65, to the first paper feed transport path 61 and that transport the recording paper sheet 6 again to the secondary transfer position T2 of the intermediate transfer device 20 via the first paper feed transport path 61, and a transport guide (not illustrated).

### Configuration of Control Device

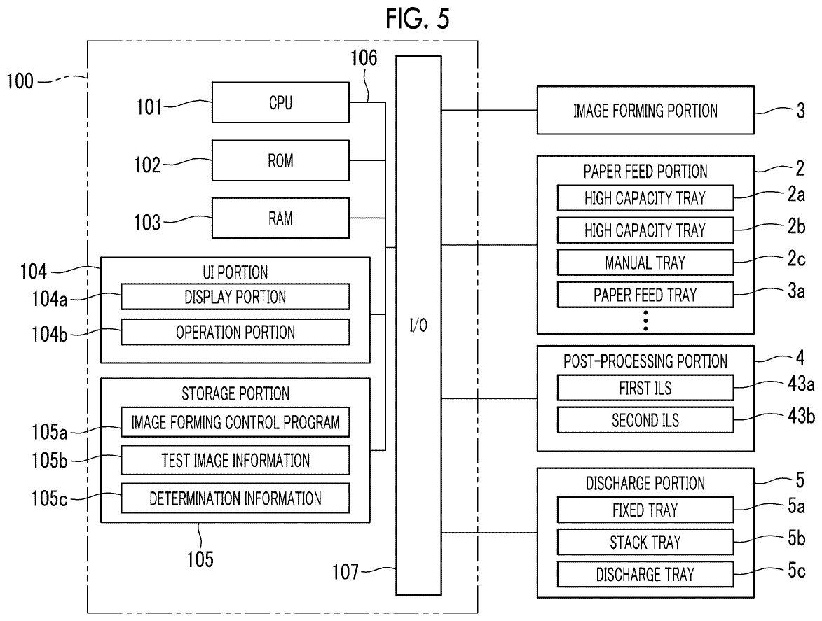

As illustrated in FIG. 1, the image forming apparatus 1 includes a control device 100 configured with a computer and the like. As illustrated in FIG. 5, the control device 100 includes a central processing unit (CPU) 101 as an example of a processor, a read only memory (ROM) 102, a random access memory (RAM) 103, a user interface (UI) portion 104 as an example of a setting unit, a storage portion 105 as an example of a storage unit consisting of a non-volatile memory or the like, and a bus 106 that connects the CPU 101, the ROM 102, and the like, an input/output (I/O) interface 107, a timer circuit 108 as an example of a tracking unit that tracks time together with date information, and the like. The timer circuit 108 tracks various times including date and time information, such as when a job executed by the image forming portion 3 is started or finished, or as will be described later, a time at which correction amount data is acquired, in accordance with an instruction from the CPU 101.

The CPU 101 controls an operation of the whole image forming apparatus 1 in an integrated manner based on an image forming control program 105a as an example of the image forming program according to the present Exemplary Embodiment 1 stored in the storage portion 105. A part of or the whole image forming control program 105a may be stored in the ROM 102 or the like. In this case, the image forming control program 105a for executing only a part of the image forming control program 105a as a subroutine can be stored in the storage portion 105. The ROM 102 stores an image forming control program related to a basic image forming operation in the image forming control program 105a. The storage portion 105 stores test image information 105b, determination information 105c, correction amount information 105d, and the like. The test image information 105b is information about the test image formed on the recording paper sheet 6 by the image forming portion 3 of the image forming apparatus 1 at a predetermined timing. The determination information 105c is information including a plurality of predetermined threshold values for determining whether or not the test image formed on the recording paper sheet 6 is appropriate based on the test image information 105b. The correction amount information 105d is information including a correction amount for correcting the misregistration of the image obtained by reading the test image.

The UI portion 104 includes a display portion 104a and an operation portion 104b for the user to operate the image forming apparatus 1. The display portion 104a and the operation portion 104b are configured with a liquid crystal display panel or the like having a touch panel function. The user selects and executes a required function from various functions of the image forming apparatus 1 displayed on the display portion 104a via the operation portion 104b.

The CPU 101 executes a print operation selected by the user via the UI portion 104, by controlling the image forming portion 3, the paper feed portion 2, the post-processing portion 4, and the discharge portion 5 of the image forming apparatus 1 via the input/output (I/O) interface 107 based on the image forming control program 105a.

In Exemplary Embodiment 1, the image forming control program 105a executed by the image forming apparatus 1 may be provided in a state where the image forming control program 105a is stored in a computer readable storage medium such as a magnetic storage medium (a magnetic tape, a magnetic disk (an HDD, a flexible disk (FD), or the like), or the like), an optical storage medium (an optical disk (a compact disk (CD), a digital versatile disk (DVD), or the like)), a magneto-optical storage medium, or a semiconductor memory (a flash ROM or the like). The image forming control program 105a may be downloaded via a network such as the Internet.

### Basic Operation of Image Forming Apparatus

Hereinafter, a basic image forming operation of the image forming apparatus 1 will be described.

The image forming apparatus 1 executes a print job of forming the image on the single or the plurality of recording paper sheets 6 in accordance with image information transmitted from a host computer or the like based on instruction information of a request for the image forming operation (print) selected by the user by operating the UI portion 104. The job is processing or a set of processing executed by the image forming apparatus 1 in order to execute the image forming operation.

Here, the image forming operation in forming a full color image configured with a combination of toner images of four colors (Y, M, C, and K) using the above four image creating devices 10 (Y, M, C, and K) will be described. The image forming operation in forming an image obtained by combining toner images of a single color or a plurality of colors using any one or more image creating devices 10 among the four image creating devices 10 (Y, M, C, and K) is basically the same.

In a case where the image forming portion 3 of the image forming apparatus 1 receives the instruction information of the request for the image forming operation (print) selected by the user by operating the UI portion 104, the four image creating devices 10 (Y, M, C, and K), the intermediate transfer device 20, the secondary transfer device 30, the fixing device 40, and the like start under control of the control device 100.

As illustrated in FIG. 3, in the image forming portion 3 of the image forming apparatus 1, first, each photoreceptor drum 11 rotates in the direction indicated by arrow A in each image creating device 10 (Y, M, C, and K). Each charging device 12 charges a front surface of each photoreceptor drum 11 to a required polarity (in Exemplary Embodiment 1, a negative polarity) and potential. Next, the exposure device 13 irradiates the charged front surface of the photoreceptor drum 11 with light emitted based on the signal of the image obtained by converting the information about the image input into the image forming apparatus 1 into each color component (Y, M, C, and K), and forms each electrostatic latent image of each color component configured with a required difference in potential on the front surface.

Here, the information about the image input into the image forming apparatus 1 is information about the image with which the user wants to form (print) the image on the recording paper sheet 6. In the image forming apparatus 1 according to Exemplary Embodiment 1, the information about the image includes the test image information 105b stored in the storage portion 105 of the control device 100 in addition to the information about the image with which the user wants to form (print) the image on the recording paper sheet 6.

Next, each developing device 14 performs developing by supplying the toner of the corresponding colors (Y, M, C, and K) charged to the required polarity (the negative polarity) to electrostatically adhere to the electrostatic latent images of each color component formed on the photoreceptor drum 11. Through such developing, the electrostatic latent images of each color component formed on each photoreceptor drum 11 are visualized as the toner images of four colors (Y, M, C, and K) developed with the toner of the corresponding colors, respectively.

Next, in a case where the toner images of each color formed on the photoreceptor drum 11 of each image creating device 10 (Y, M, C, and K) are transported to the primary transfer position T1, the primary transfer device 15 primarily transfers the toner images of each color to the intermediate transfer belt 21 rotating in the direction indicated by arrow B of the intermediate transfer device 20 in a state where the toner images are sequentially superimposed on each other.

In each image creating device 10 (Y, M, C, and K) after the end of the primary transfer, the drum cleaning device 16 cleans the front surface of the photoreceptor drum 11 by scraping to remove the adhering substance. Accordingly, each image creating device 10 (Y, M, C, and K) is in a state where a subsequent image creating operation can be performed.

Next, in the intermediate transfer device 20, as illustrated in FIG. 3, the primarily transferred toner images are held and transported to the secondary transfer position T2 through rotation of the intermediate transfer belt 21. Meanwhile, in the high capacity trays 2a and 2b provided in the paper feed portion 2 of the image forming apparatus 1, the required recording paper sheet 6 is fed to the second paper feed transport path 62 in accordance with the image creating operation. The recording paper sheet 6 fed from the high capacity trays 2a and 2b to the second paper feed transport path 62 is transported to the first paper feed transport path 61 of the image forming portion 3. In the first paper feed transport path 61, the paper sheet transport roll pair 68 as resist rolls supplies the recording paper sheet 6 to the secondary transfer position T2 by feeding the recording paper sheet 6 in accordance with a transfer timing. The recording paper sheet 6 on which the image is formed is not limited to the recording paper sheet 6 supplied from the high capacity trays 2a and 2b and may be the recording paper sheet 6 supplied from the paper feed device 50.

At the secondary transfer position, the secondary transfer roll 31 secondarily transfers the toner images on the intermediate transfer belt 21 to the recording paper sheet 6 at once. In the intermediate transfer device 20 after the end of the secondary transfer, the belt cleaning devices 28 and 29 perform cleaning by removing the adhering substance such as the toner remaining on the front surface of the intermediate transfer belt 21 after the secondary transfer.

Next, the recording paper sheet 6 on which the toner images are secondarily transferred is peeled off from the intermediate transfer belt 21 and the secondary transfer roll 31, and then transported to the fixing device 40 along the intermediate transport path 63. In the fixing device 40, the non-fixed toner images are fixed to the recording paper sheet 6 through necessary fixing processing (heating and pressing) by introducing the recording paper sheet 6 after the secondary transfer to pass through the fixing processing portion between the rotating heating rotor 401 and the rotating pressing rotor 402. Cooling processing or the bending correction processing is performed, as necessary, on the recording paper sheet 6 after the end of the fixing. Then, in a case where the image is formed on only one side of the recording paper sheet 6, the recording paper sheet 6 is discharged from the image forming portion 3 to the post-processing portion 4 by the discharge roll pair 70 via the discharge transport path 64.

In a case where the image is formed on two sides of the recording paper sheet 6, the recording paper sheet 6 on which the image is formed on one side is not discharged to the post-processing portion 4, and the transport direction of the recording paper sheet 6 is switched downward to the reversal transport path 65 along the vertical direction Z. The front and the rear of the recording paper sheet 6 transported to the reversal transport path 65 are reversed by the reversal roll pair 72, and then the recording paper sheet 6 is transported to the two-sided transport path 66. The recording paper sheet 6 of which the front and the rear are reversed is transported to the first paper feed transport path 61 again via the two-sided transport path 66, and the toner images are transferred to the rear side of the recording paper sheet 6 at the secondary transfer position T2 of the intermediate transfer device 20. In the recording paper sheet 6 on which the toner images are secondarily transferred, the non-fixed toner images are fixed by the fixing device 40, and the recording paper sheet 6 is discharged from the image forming portion 3 to the post-processing portion 4 by the discharge roll pair 70 via the discharge transport path 64.

Through the above operation, a full color image or the like formed by combining the toner images consisting of four colors (Y, M, C, and K) on one side or two sides of the recording paper sheet 6 is output.

As illustrated in FIG. 2, in the post-processing portion 4, the required post-processing such as the bending correction processing, the inspection (reading) processing of the image, the stack processing, the binding processing, the folding processing, and the perforation processing is performed on the recording paper sheet 6 on which the image is formed on one side or two sides by the image forming portion 3. The recording paper sheet 6 on which the post-processing is performed is discharged to the fixed tray 5a, the stack tray 5b, the booklet tray 5c, and the like of the discharge portion 5.

In the image forming apparatus 1 configured as described above, the image wanted by the user is printed on the designated recording paper sheet 6 in accordance with the print operation selected and designated by the user via the UI portion 104.

As illustrated in FIG. 3, the image forming portion 3 of the image forming apparatus 1 forms the toner images of each color in each image creating device 10 (Y, M, C, and K) of yellow (Y), magenta (M), cyan (C), and black (K). The toner images of each color formed by each image creating device 10 (Y, M, C, and K) are transferred to the recording paper sheet 6 in a superimposed manner on each other on the intermediate transfer belt 21 of the intermediate transfer device 20 and then fixed by the fixing device 40. Accordingly, an image such as a full color image is formed. Here, in the image forming portion 3 of the image forming apparatus 1, the misregistration, the size deviation, or the density deviation (including tone deviation) may occur in the images of each color of yellow (Y), magenta (M), cyan (C), and black (K) that are formed by each image creating device 10 (Y, M, C, and K) and that are superimposed on each other on the intermediate transfer belt 21 of the intermediate transfer device 20.

Then, in the image forming apparatus 1, the misregistration or the size deviation of the image or the density or tone deviation of the image occurs in the image finally formed on the single or the plurality of recording paper sheets 6 in the image forming portion 3, and the image wanted by the user (a target image) may not be printed.

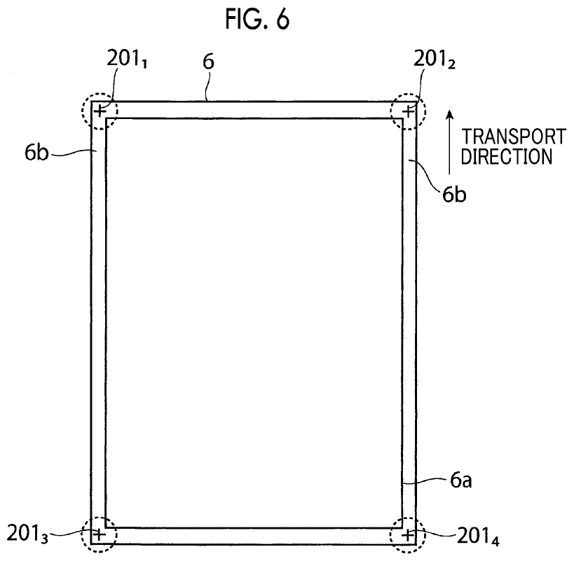

Therefore, in the image forming apparatus 1 according to Exemplary Embodiment 1, as illustrated in FIG. 6, the image forming portion 3 forms a misregistration detection pattern 201 at the same time on the recording paper sheet 6 of at least the first page in addition to the image wanted by the user. The misregistration detection pattern 201 is an example of the test image formed based on the test image information 105b. Here, while the misregistration and the size deviation of the image are described, the invention can also be applied to density deviation and tone deviation of the image.

The misregistration detection pattern 201 is an image for detecting the misregistration and the size deviation of the image. As illustrated in FIG. 2, in the image forming apparatus 1, the image inspection device 43 of the post-processing portion 4 reads the recording paper sheet 6 on which the misregistration detection pattern 201 is formed in the image forming portion 3. The control device 100 detects the misregistration or the size deviation of the image in accordance with a reading result of the image inspection device 43. The control device 100 calculates a correction amount of the misregistration for correcting the misregistration or the size deviation of the image. The control device 100 has a real time correction function of correcting a position and a size of the image in the image forming portion 3 in real time in accordance with the correction amount of the misregistration of the image. Here, the real time correction is execution of an operation of correcting the position of the image, the density of the image, and the like during execution of one print job. A stop operation of temporarily stopping the print job, and the like may be included in the middle of one print job. The correction amount of the misregistration and the size deviation of the image is a value having the same magnitude and the opposite sign to the deviation amount of the misregistration and the size deviation of the image. Thus, in Exemplary Embodiment 1, even in a case where the deviation amount of the misregistration and the size deviation of the image is simply described, the deviation amount may mean the correction amount of the misregistration and the size deviation of the image.

The CPU 101 of the control device 100 is an example of a correction unit that, in continuously forming the image on the plurality of recording paper sheets 6 in the image forming portion 3, obtains and corrects a correction amount for correcting an image forming condition in accordance with a reading result of an image of the misregistration detection pattern 201 formed on a specific number (n=an integer of 1 or more) of recording paper sheets 6 at a predetermined timing such as immediately after the start of forming of the image, based on the image forming control program 105a stored in the storage portion 105.

### Configuration of Test Image

As illustrated in FIG. 6, the test image is configured with the misregistration detection pattern 201. For example, the misregistration detection pattern 201 is formed in a region other than an original document area 6a in which the image wanted by the user is formed on the recording paper sheet 6. In the illustrated example, the region is a margin part 6b such as upper, lower, right, and left margins positioned on an outer periphery of the original document area 6a.

Here, the original document area 6a is a region having a required size including a standard size such as A4 size (210×297 mm) or A3 size (297×420 mm) for forming the image wanted by the user. In this case, for example, a paper sheet having A4 extended size or A3 extended size slightly larger than the standard size such as A4 size or A3 size is used as the recording paper sheet 6. A size of the recording paper sheet 6 is not limited to a size larger than the standard size and may also be the standard size such as A4 size or A3 size. In this case, the misregistration detection pattern 201 formed in the margin part 6b of the recording paper sheet 6 having the standard size is cut and removed in the post-processing portion 4.

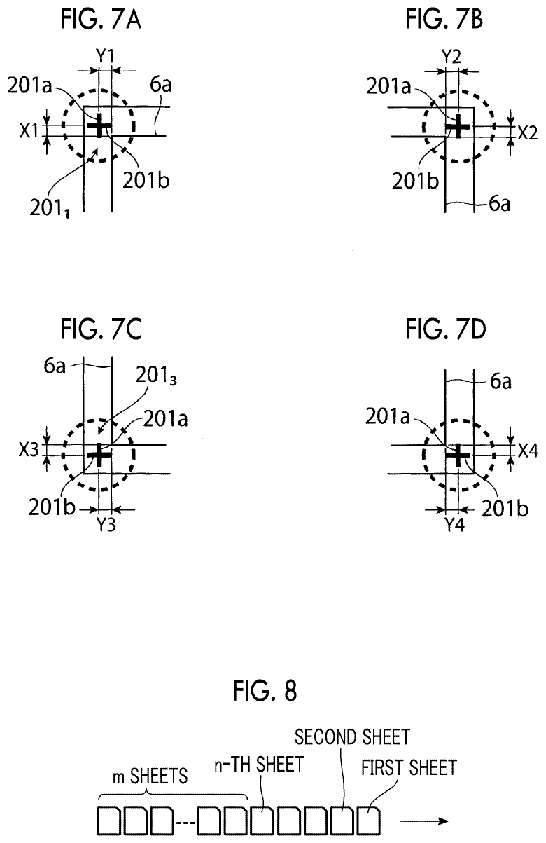

As illustrated in FIG. 6, for example, misregistration detection patterns 201₁ to 201₄ are respectively formed at four corners of the recording paper sheet 6, that is, four corner portions including an upper left portion and an upper right portion along a width direction intersecting with the transport direction of the recording paper sheet 6 and a lower left portion and a lower right portion along the transport direction of the recording paper sheet 6. The misregistration detection patterns 201₁ to 201₄ may have any colors. For example, the misregistration detection patterns 201₁ to 201₄ are formed in black (K). As illustrated in FIGS. 7A to 7D, for example, cross-shaped images consisting of a straight line image 201a along the transport direction of the recording paper sheet 6 and a straight line image 201b along a direction intersecting with the transport direction of the recording paper sheet 6 are used as the misregistration detection patterns 201₁ to 201₄. The straight line image 201a is formed at a position separated from the original document area 6a of the recording paper sheet 6 by predetermined distances (Y1, Y2, Y3, and Y4) along the width direction intersecting with the transport direction of the recording paper sheet 6. The straight line image 201b is formed at a position separated from the original document area 6a of the recording paper sheet 6 by predetermined distances (X1, X2, X3, and X4) along the transport direction of the recording paper sheet 6. For example, all of these distances (Y1, Y2, Y3, and Y4) and distances (X1, X2, X3, and X4) are set to equal values. The misregistration detection patterns 201₁ to 201₄ are not limited to four locations and may be provided at more than four locations, such as six locations or eight locations.

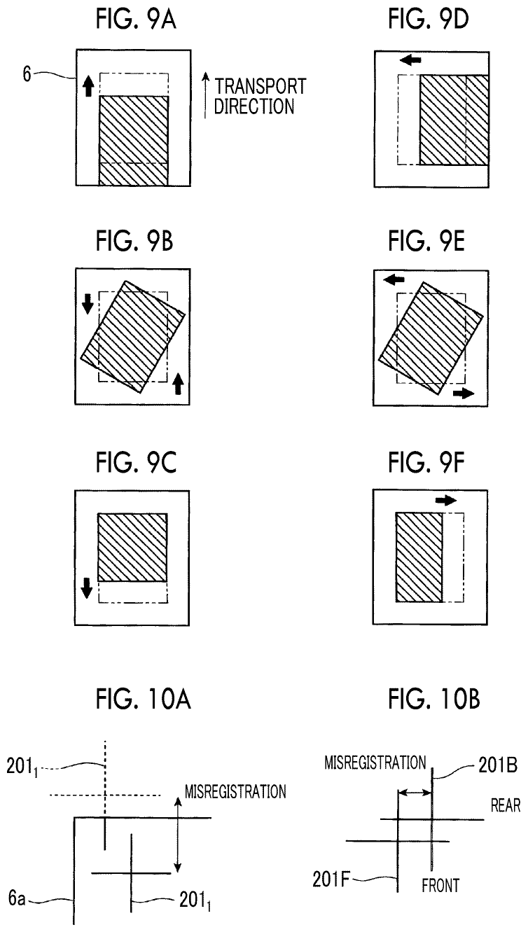

As illustrated in FIGS. 9A to 9F, the misregistration and the size deviation of the image can be classified into X direction misregistration, perpendicularity deviation, X direction magnification deviation, Y direction misregistration, obliqueness deviation, and Y direction magnification deviation. The X direction misregistration is, as illustrated in FIG. 9A, misregistration in which the image deviates parallel to the transport direction of the recording paper sheet 6. A deviation amount of the X direction misregistration is given as target value {(X2−X1)/2}. The perpendicularity deviation is, as illustrated in FIG. 9B, misregistration in which the image deviates in an inclined manner in a counterclockwise direction with respect to a perpendicular direction that is the transport direction of the recording paper sheet 6. A deviation amount of the perpendicularity deviation is given as X2−X1. The X direction magnification deviation is, as illustrated in FIG. 9C, size deviation of the image in which a position at which the image is formed with respect to the recording paper sheet 6 is correct, but a magnification (a size) of the image deviates along the transport direction of the recording paper sheet 6. A deviation amount of the X direction magnification deviation is given as paper sheet size {(X2−X1)/2}−{(X4−X3)/2}. The Y direction misregistration is, as illustrated in FIG. 9D, misregistration in which the image deviates parallel to the direction intersecting with the transport direction of the recording paper sheet 6. A deviation amount of the Y direction misregistration is given as target value −{(Y2−Y1)/2}. The obliqueness deviation is, as illustrated in FIG. 9E, misregistration in which the image deviates in an inclined manner with respect to the direction intersecting with the transport direction of the recording paper sheet 6. A deviation amount of the obliqueness deviation is given as Y2−Y1. The Y direction magnification deviation is, as illustrated in FIG. 9F, size deviation of the image in which a position at which the image is formed with respect to the recording paper sheet 6 is correct, but the magnification (the size) of the image deviates along the direction intersecting with the transport direction of the recording paper sheet. A deviation amount of the Y direction magnification deviation is given as paper sheet size −{(Y2−Y1)/2}−{(Y4−Y3)/2}. The misregistration and the size deviation occurring in the image formed on the recording paper sheet 6 consist of a combination of one or more of the X direction misregistration, the perpendicularity deviation, the X direction magnification deviation, the Y direction misregistration, the obliqueness deviation, and the Y direction magnification deviation.

The misregistration of the image includes not only misregistration occurring on one side of the recording paper sheet 6 as illustrated in FIG. 10A but also misregistration occurring between the front side and the rear side of the recording paper sheet 6 as illustrated in FIG. 10B. The misregistration occurring between the front side and the rear side of the recording paper sheet 6 is separately detected as misregistration on the front side of the recording paper sheet 6 and misregistration on the rear side of the recording paper sheet 6 based on a misregistration detection pattern 201F formed on the front side of the recording paper sheet 6 and on a detection pattern 201B formed on the rear side of the recording paper sheet 6.

The control device 100 calculates whether or not the X direction misregistration, the perpendicularity deviation, the X direction magnification deviation, the Y direction misregistration, the obliqueness deviation, and the Y direction magnification deviation occur and the deviation amounts of the X direction misregistration, the perpendicularity deviation, the X direction magnification deviation, the Y direction misregistration, the obliqueness deviation, and the Y direction magnification deviation based on positional information (X1, Y1), (X2, Y2), (X3, Y3), and (X4, Y4) of the misregistration detection patterns 201₁ to 201₄ detected by the image inspection device 43 of the post-processing portion 4.

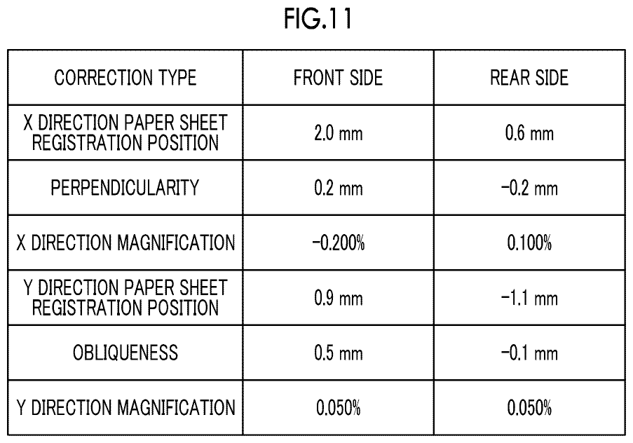

As illustrated in FIG. 11, for example, the calculated deviation amount of each of the X direction misregistration, the perpendicularity deviation, the X direction magnification deviation, the Y direction misregistration, the obliqueness deviation, and the Y direction magnification deviation is obtained as “2.0 mm”, “0.2 mm”, “−0.200%”, “0.9 mm”, “0.5 mm”, and “0.050%” on the front side of the recording paper sheet 6.

In the same manner, as illustrated in FIG. 11, the calculated deviation amount of each of the X direction misregistration, the perpendicularity deviation, the X direction magnification deviation, the Y direction misregistration, the obliqueness deviation, and the Y direction magnification deviation is obtained as “0.6 mm”, “−0.2 mm”, “0.100%”, “−1.1 mm”, “−0.1 mm”, and “0.050%” on the rear side of the recording paper sheet 6.

The control device 100 determines whether or not the calculated deviation amount of each of the X direction misregistration, the perpendicularity deviation, the X direction magnification deviation, the Y direction misregistration, the obliqueness deviation, and the Y direction magnification deviation falls within a range of a predetermined threshold value (an upper limit value and a lower limit value). The predetermined threshold value (the upper limit value and the lower limit value) of the deviation amount of each of the X direction misregistration, the perpendicularity deviation, the X direction magnification deviation, the Y direction misregistration, the obliqueness deviation, and the Y direction magnification deviation is stored in the storage portion 105 as the determination information 105c. In a case where the control device 100 determines that the calculated deviation amount of each of the X direction misregistration, the perpendicularity deviation, the X direction magnification deviation, the Y direction misregistration, the obliqueness deviation, and the Y direction magnification deviation falls outside the range of the predetermined threshold value (the upper limit value and the lower limit value), the control device 100 corrects the misregistration and the size deviation of the image. Here, correction of the misregistration and the size deviation of the image is basically performed by changing a position at which the image is formed, and a magnification of the image in order to obtain zero misregistration and zero size deviation of the image.

The control device 100 corrects the misregistration and the size deviation of the image in exposing the image to light on the photoreceptor drum 11 in the exposure device 13 of each image creating device 10 (Y, M, C, and K) of yellow (Y), magenta (M), cyan (C), and black (K) of the image forming portion 3. In exposing the image to light via the exposure device 13 of each image creating device 10 (Y, M, C, and K), the image forming portion 3 loads image data on a memory in page units based on the image information. The misregistration and the size deviation of the image are corrected by correcting a position at which the image data is loaded, in dot units or the like to correct the deviation amounts of the X direction misregistration, the perpendicularity deviation, the X direction magnification deviation, the Y direction misregistration, the obliqueness deviation, and the Y direction magnification deviation in loading the image data on the memory. Accordingly, as described above, the deviation amount of each of the X direction misregistration, the perpendicularity deviation, the X direction magnification deviation, the Y direction misregistration, the obliqueness deviation, and the Y direction magnification deviation illustrated in FIG. 11 indicates the correction amount of the image at the same time.

As illustrated in FIG. 8, the misregistration detection pattern 201 is basically formed on only the first recording paper sheet 6 immediately after the start of forming of the image among the plurality of recording paper sheets 6 on which the image is continuously formed. However, as the misregistration detection pattern 201, identical or different misregistration detection patterns 201 may be formed on a plurality of (n) recording paper sheets 6 immediately after the start of forming of the image among the plurality of recording paper sheets 6 on which the image is continuously formed. Here, n is an integer of 1 or more. In a case where the identical misregistration detection patterns 201 are formed on the plurality of (n) recording paper sheets 6, the deviation amount of each of the X direction misregistration, the perpendicularity deviation, the X direction magnification deviation, the Y direction misregistration, the obliqueness deviation, and the Y direction magnification deviation is obtained by calculating an average value. For example, the misregistration detection pattern 201 is not limited to the misregistration detection pattern 201 immediately after the start of the printing operation and is formed at the predetermined timing such as each time the image is printed on a predetermined number of recording paper sheets 6, each time a certain amount of time elapses from the start of the print operation, when the print operation is finished, or each time the recording paper sheet 6 is changed in one job.

In the image forming apparatus 1 of the related art, an amount of the misregistration occurring in the image formed on the front side and the rear side of the recording paper sheet 6 by the image forming portion 3 changes depending on various factors. Examples of the factors that cause the amount of the misregistration of the image to change include media such as a paper type, the size, and a paper weight of the recording paper sheet 6, a direction of the recording paper sheet 6, a time at which the correction amount is calculated, a tray number indicating a tray from which the recording paper sheet 6 is fed, a temperature inside or outside the image forming portion 3, and coverage (an area ratio) of the image formed on the recording paper sheet 6 by the user.

Among the factors of changing, effects of a difference between media such as the paper type or the size of the recording paper sheet 6 and a difference between trays from which the recording paper sheet 6 is fed are high.

However, in the image forming apparatus 1 of the related art, the size, the paper weight, the material, or the like of the recording paper sheet 6 is managed using media data, and printing is set by associating the media data with tray data. Here, the correction amount data (see FIG. 11) calculated by reading the misregistration detection pattern 201 is stored in association with any of the media data or the tray data.

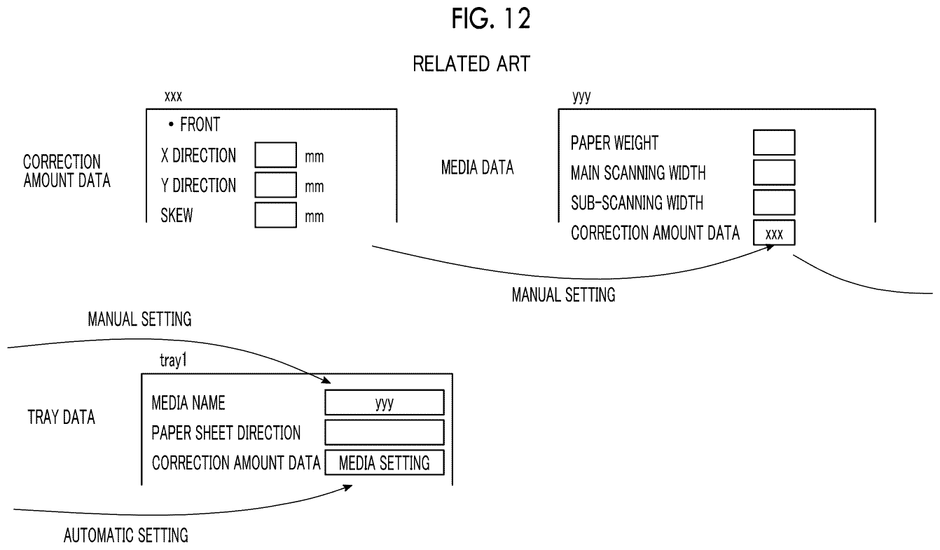

Accordingly, in a case where the correction amount data is stored in association with the media data, as illustrated in FIG. 12, “xxx” that is the correction amount data calculated by reading the misregistration detection pattern 201 is stored in the storage portion 105 as the correction amount information 105d (see FIG. 5) in association with the media data having a media name “yyy” for the user. In this case, on the display portion 104a for storing the correction amount data in the UI portion 104, the correction amount data name “xxx” stored as the correction amount information 105d (see FIG. 5) in the storage portion 105 needs to be manually set in association with the media data “yyy” of the recording paper sheet 6 on which the misregistration detection pattern 201 is formed. Meanwhile, in a case where the user selects a tray and starts the print operation on the UI portion 104, as illustrated in the lower part of FIG. 12, the user can use the correction amount data “xxx” stored in the storage portion 105 in association with the media data having the media name “yyy” for the first time as the correction amount data of tray 1 by pulling down to select “yyy” as the media name in the tray data.

Thus, in order for the user to use the correction amount data “xxx” stored in the storage portion 105 as the correction amount information 105d in association with the media data in the tray data, an operation of manually inputting the correction amount data name “xxx” in the media data “yyy” and an operation of selecting the media name “yyy” in the tray data are necessary. Accordingly, in a case where the correction amount data is stored in association with the media data, an operation in using the correction amount data associated with the media data is complicated, and a technical problem arises in that the user cannot easily use the correction amount data.

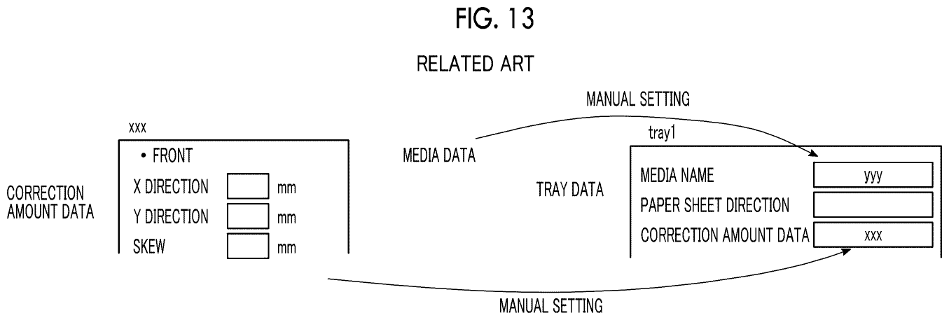

Meanwhile, in the related art, in a case where the correction amount data is stored in association with the tray data, the user, as illustrated in FIG. 13, needs to store “xxx” that is the correction amount data calculated by reading the misregistration detection pattern 201, in association with the tray data. Thus, for example, in the tray data of tray 1 accommodating the recording paper sheet 6 on which the misregistration detection pattern 201 is formed, two operations including an operation in which the user manually sets the media name “yyy”, and an operation in which the user manually sets the correction amount data name “xxx” are necessary. In addition, in a case where the user selects a tray and starts the print operation on the UI portion 104, as illustrated in FIG. 13, the user can use the correction amount data “xxx” of tray 1 stored in the storage portion 105 as the correction amount information 105d in association with the tray data for the first time as the correction amount data of tray 1 by selecting “yyy” as the media name through a pull-down operation in the tray data.

Thus, in order for the user to use the correction amount data stored in association with the tray data in the tray data, two operations including an operation of inputting the correction amount data name “xxx” in the tray data of tray 1 accommodating the recording paper sheet 6 on which the misregistration detection pattern 201 is formed and an operation of selecting the media name “yyy” in the tray data are necessary. Accordingly, even in a case where the correction amount data is stored in association with the tray data, the operation in using the correction amount data is also complicated, and a technical problem arises in that the user cannot easily use the correction amount data.

### Configuration of Characteristic Part of Image Forming Apparatus

Therefore, in order to address such technical problems, in the image forming apparatus according to Exemplary Embodiment 1, the storage unit is configured to store the correction amount in association with both of medium information for specifying the recording medium and supply portion information for specifying the supply portion.

That is, as illustrated in FIG. 5, the image forming apparatus 1 according to Exemplary Embodiment 1 includes, in the control device 100, the CPU 101 functioning as the correction unit that corrects the condition in accordance with the reading result of the image formed on the specific number of recording paper sheets 6 immediately after the start of forming of the image in continuously forming the image on the plurality of recording paper sheets 6, 6, . . . .

In a case where the print operation is designated in the image forming apparatus 1, the CPU 101 functioning as the correction unit, as illustrated in FIG. 8, executes an operation of printing the image obtained by adding the misregistration detection pattern 201 as the test image to the image designated by the user on the specific number n of recording paper sheets 6 at the predetermined timing such as immediately after the start of forming of the image among the plurality of continuous recording paper sheets.

The CPU 101 reads the misregistration detection pattern 201 formed on the recording paper sheet 6 in the image inspection device 43 of the post-processing portion 4.

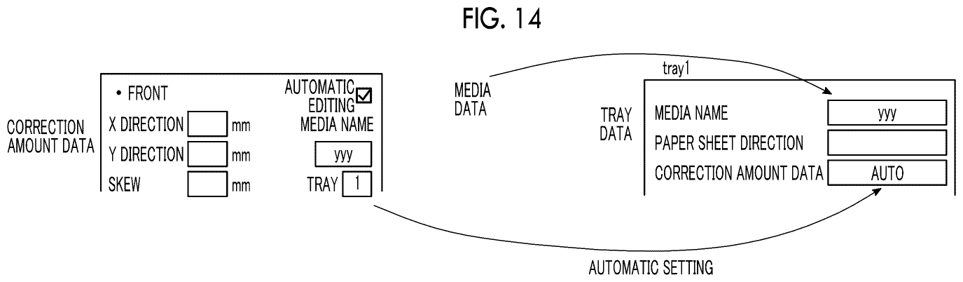

Basically, the control device 100 obtains the correction amount of the misregistration and the size deviation of the image in accordance with the reading result of the misregistration detection pattern 201 and stores the correction amount in the storage portion 105 as an example of the storage unit as the correction amount information 105d. Here, as illustrated in FIG. 14, the storage portion 105 is configured to store the correction amount data calculated by reading the misregistration detection pattern 201 as the correction amount information 105d in association with both of the media name “yyy” as an example of the medium information and the tray number “1” as an example of the supply portion information. Accordingly, in a case where the user starts a new print operation, the user may simply perform an operation of simply opening the tray data of “tray 1” and selecting “yyy” that is the media name of the recording paper sheet 6 on which the misregistration detection pattern 201 is formed, from the media data as the media name through a pull-down operation or the like. Then, the correction amount data of the recording paper sheet 6 having the media name “yyy” accommodated in “tray 1” is automatically associated with the correction amount information 105d of the storage portion 105, and the correction amount data can be read and set to be used from the correction amount information 105d of the storage portion 105.

Storage processing of the correction amount is not limited to a case where the real time correction is executed in the image forming apparatus 1. For example, the same can be applied to a case where the user calculates the correction amount by reading the image of the recording paper sheet 6 on which the misregistration detection pattern 201 as the test image is formed in advance, and stores the calculated correction amount in the storage portion 105.

### Operation of Characteristic Part of Image Forming Apparatus

In the image forming apparatus according to Exemplary Embodiment 1, the following is performed to enable effective use of the stored correction amount compared to a case where the correction amount for correcting the image forming condition is stored in association with only any one of the medium information for specifying the recording medium or the supply portion information for specifying the supply portion.

That is, in the image forming apparatus 1 according to Exemplary Embodiment 1, in a case where the user executes a series of printing processing, as illustrated in FIG. 5, the user sets a print job that the user wants, such as the size and the material of the recording paper sheet 6 for forming the image, the tray from which the recording paper sheet 6 is fed, the number of printed sheets, or the content of the post-processing executed by the post-processing portion 4, and executes the print operation by operating the operation portion 104b while viewing a screen displayed on the display portion 104a of the UI portion 104.

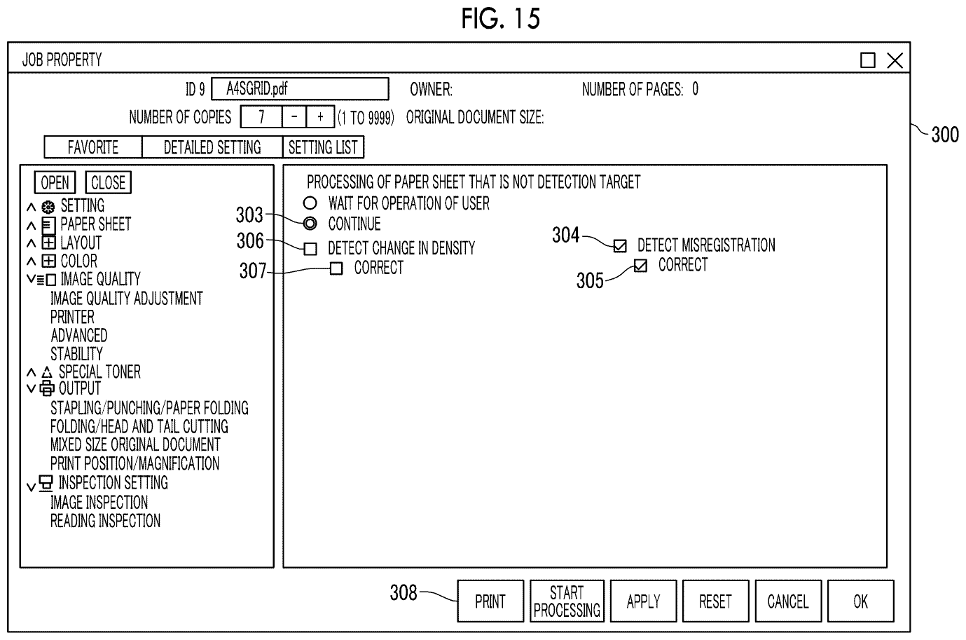

Here, as illustrated in FIG. 15, the user, for example, operates an operation screen 300 of a job property constituting the display portion 104a and the operation portion 104b of the UI portion 104. The user touches to check a display portion 304 of a function “detect misregistration” and touches to check a display portion 305 of a function “correct” on the operation screen 300 of the job property and operates a print button 308.

Accordingly, the CPU 101 automatically forms the misregistration detection pattern 201 on the recording paper sheet 6 in executing the print operation in the image forming portion 3 of the image forming apparatus 1. The CPU 101 calculates the correction amount by reading the misregistration detection pattern 201 via the image inspection device 43 of the post-processing portion 4 and executes the so-called real time correction of correcting the misregistration and the size deviation of the image.

In the illustrated Exemplary Embodiment 1, in processing a paper sheet that is not a detection target, a display portion 303 of “continue” is touched and displayed with a double circle on the operation screen 300 of the job property of FIG. 15. Both of a display portion 306 of “detect change in density” and a display portion 307 of “correct” are not touched to be checked on the operation screen 300 of the job property.

As illustrated in FIG. 8, the image forming apparatus 1 according to Exemplary Embodiment 1 forms the misregistration detection pattern 201 on the specific number of (n) recording paper sheets 6 immediately after the start of the job. Here, the CPU 101 reads the misregistration detection pattern 201 in the image inspection device 43, detects the deviation amount of the misregistration or the size deviation of the image in accordance with the reading result of the misregistration detection pattern 201, and calculates the correction amount of the misregistration or the size deviation of the image. The CPU 101 corrects the image to be formed on the recording paper sheet 6 in accordance with the obtained correction amount of the misregistration or the size deviation of the acquired image.

Here, as illustrated in FIG. 11, the deviation amount of the misregistration and the size deviation of the image obtained in accordance with the reading result of the misregistration detection pattern 201 is calculated as the X direction misregistration, the perpendicularity deviation, the X direction magnification deviation, the Y direction misregistration, the obliqueness deviation, and the Y direction magnification deviation.

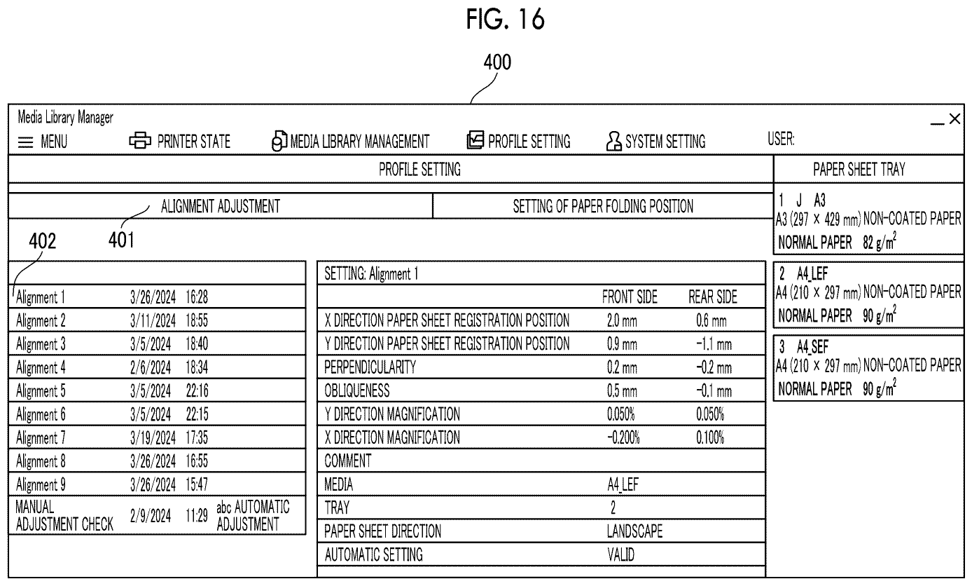

As illustrated in FIG. 16, the deviation amount of the misregistration and the size deviation of the image calculated as described above is displayed by selecting a function 401a of alignment adjustment in a profile setting on a screen 400 of Media Library Manager. Here, the alignment adjustment information is displayed with names such as “Alignment 1”, “Alignment 2”, “Alignment 3”, . . . . For example, in a case where “Alignment 1” 402 is clicked and selected, each deviation amount is displayed in association with the acquired date and time information, a size “A4_LEF” of the recording paper sheet 6 that is one piece of the media data, and a tray number “2” that is the tray data and that accommodates the recording paper sheet 6 of the size “A4_LEF”. These pieces of the correction amount data are stored in the storage portion 105 as the correction amount information 105d.

More specifically, the deviation amount of each of the X direction misregistration, the perpendicularity deviation, the X direction magnification deviation, the Y direction misregistration, the obliqueness deviation, and the Y direction magnification deviation, the date and time information at which the deviation amount is acquired, the media data “A4_LEF” of the recording paper sheet 6, and the tray number “2” that is the tray data are stored in the storage portion 105 in the name of “Alignment 1” as the correction amount information 105d. The same applies to other “Alignment 2”, “Alignment 3”, . . . .

In executing the subsequent print operation, the user sets content of the print job using the operation portion 104b of the UI portion 104.

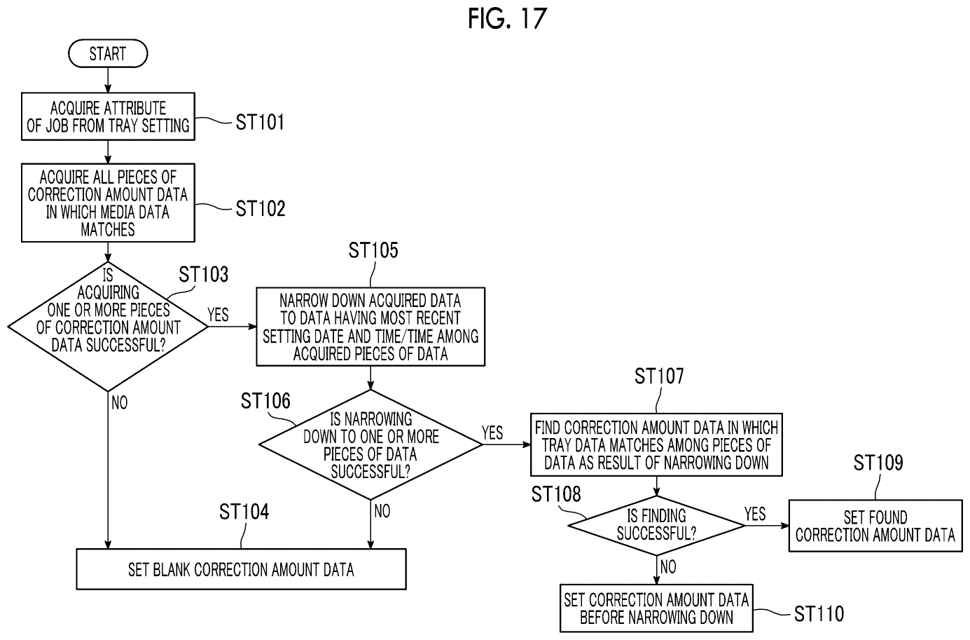

Then, as illustrated in FIG. 17, the CPU 101 acquires an attribute of the job in accordance with a job condition of each tray such as the high capacity trays 2a and 2b of the paper feed portion 2 and the paper feed trays 3b, 3c, and 3d of the image forming portion 3, in accordance with the content of the print job set using the operation portion 104b of the UI portion 104 (step S101).

Here, a case where the recording paper sheet 6 is fed using any of three paper feed trays 3b, 3c, and 3d disposed in the image forming portion 3 as the tray will be described. The uppermost paper feed tray 3b will be referred to as “tray 1”, the middle paper feed tray 3c will be referred to as “tray 2”, and the lowermost paper feed tray 3d will be referred to as “tray 3”.

As illustrated in FIG. 17, the CPU 101 acquires all pieces of the correction amount data in which the media data matches, from the correction amount data stored in the correction amount information 105d of the storage portion 105 (step S102). The CPU 101 determines whether or not one or more pieces of the correction amount data are acquired (step S103), and in a case where one or more pieces of the correction amount data are not acquired, determines that there is no available correction amount data and sets blank correction amount data (step S104).

While only the content of “Alignment 1” is displayed in the example illustrated in FIG. 16, all pieces of the correction amount data in which the media data matches in “Alignment 2” to “Alignment 9” are acquired.

In a case where the CPU 101 determines that one or more pieces of the correction amount data are acquired (step S103), the CPU 101 narrows down the acquired data to the latest data having the most recent setting date and time/time among the acquired pieces of data (step S105). In the example illustrated in FIG. 16, in a case where all pieces of the media data match, data of “Alignment 8” has the most recent setting date and time/time as “2024/3/26 16:55” and thus, is selected.

Then, the CPU 101 determines whether or not narrowing down the acquired data to one or more pieces of data having the most recent setting date and time/time among the acquired pieces of data is successful (step S106). In a case where narrowing down the acquired data to one or more pieces of data having the most recent setting date and time/time among the acquired pieces of data is not successful, the CPU 101 sets blank correction amount data (step S104).

Here, examples of a case where narrowing down the acquired data to one or more pieces of data having the most recent setting date and time/time among the acquired pieces of data is not successful include a case where one or more pieces of data having the most recent setting date and time/time are present among the acquired pieces of data, and a predetermined period elapses from the acquisition.

Meanwhile, in a case where narrowing down to one or more pieces of data is successful, the CPU 101 finds the correction amount data in which the tray data matches among the pieces of data that are successfully narrowed down (step S107).

Next, the CPU 101 determines whether or not finding the correction amount data in which the tray data matches is successful (step S108). In a case where finding the correction amount data in which the tray data matches is successful, the CPU 101 sets the found correction amount data (step S109).

In a case where finding the correction amount data in which the tray data matches is not successful, the CPU 101 sets the correction amount data before narrowing down (step S110).

Then, the CPU 101 starts the print operation.

Here, in executing the print operation in the image forming portion 3 of the image forming apparatus 1, the latest correction amount data in which the media data and the tray data match is set among the pieces of correction data stored in the storage portion 105 as the correction amount information 105d.

Accordingly, in starting the print operation, even in a case where the real time correction is executed by forming the misregistration detection pattern 201 on the first recording paper sheet 6, the CPU 101 can apply the latest correction amount data in which the media data and the tray data match, and can form the image in which the misregistration and the size deviation are corrected.

Here, even in a case where the correction data stored in the storage portion 105 as the correction amount information 105d is used, the user does not need to perform the operation of manually inputting the correction amount data name “xxx” in the media data “yyy” or the operation of selecting the media name “yyy” in the tray data.

In the image forming apparatus 1 according to Exemplary Embodiment 1, in storing the correction amount data in the storage portion 105 as the correction amount information 105d, the CPU 101 automatically stores the correction amount data in association with both of the media data and the tray data. In a case where the print operation is started under a print condition set by the user on the UI portion 104, the image forming apparatus 1 is configured to preferentially set the correction amount data in which both of the media data and the tray data match.

Thus, the image forming apparatus 1 according to Exemplary Embodiment 1 may effectively use the stored correction amount compared to a case where the correction amount for correcting the image forming condition is stored in association with only any one of the medium information for specifying the recording medium or the supply portion information for specifying the supply portion.

### Exemplary Embodiment 2

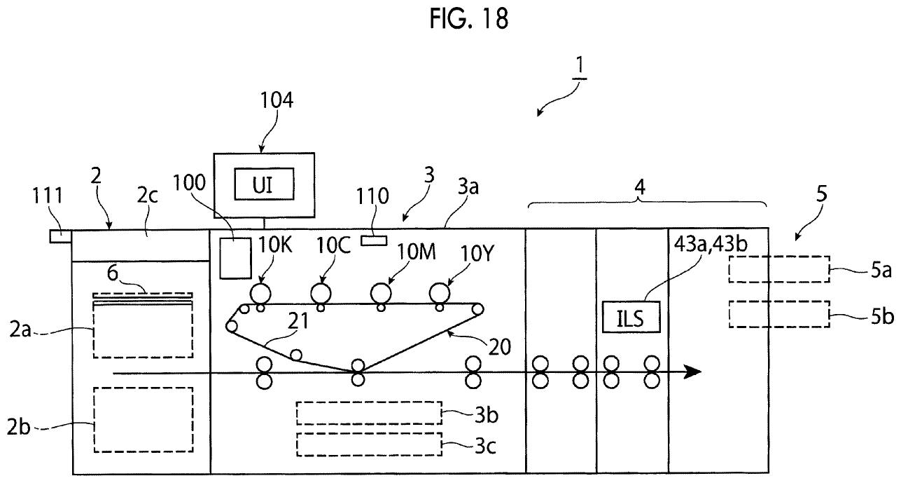

FIG. 18 is a schematic diagram illustrating an overall configuration of an image forming apparatus to which an image forming program and an image forming system according to Exemplary Embodiment 2 are applied.

The image forming apparatus according to Exemplary Embodiment 2 includes an environment detection unit that detects at least one of a temperature or humidity inside and outside the image forming apparatus, in which the storage unit is configured to store the correction amount in association with at least one of environment information detected by the environment detection unit in a case where the correction amount is obtained, or density information of the image in a case where the correction amount is obtained, in addition to the medium information and the supply portion information.

Exemplary Embodiment 2 is configured to include a prohibition unit that prohibits the user from accessing a portion of information stored in the storage unit.

That is, as illustrated in FIG. 18, the image forming apparatus 1 according to Exemplary Embodiment 2 includes a first environment sensor 110 as an example of the environment detection unit that detects the temperature and the humidity inside the image forming portion 3.

The image forming apparatus 1 according to Exemplary Embodiment 2 includes a second environment sensor 111 as an example of the environment detection unit that detects the temperature and the humidity outside the image forming portion 3, on an upper end portion of the paper feed portion 2.

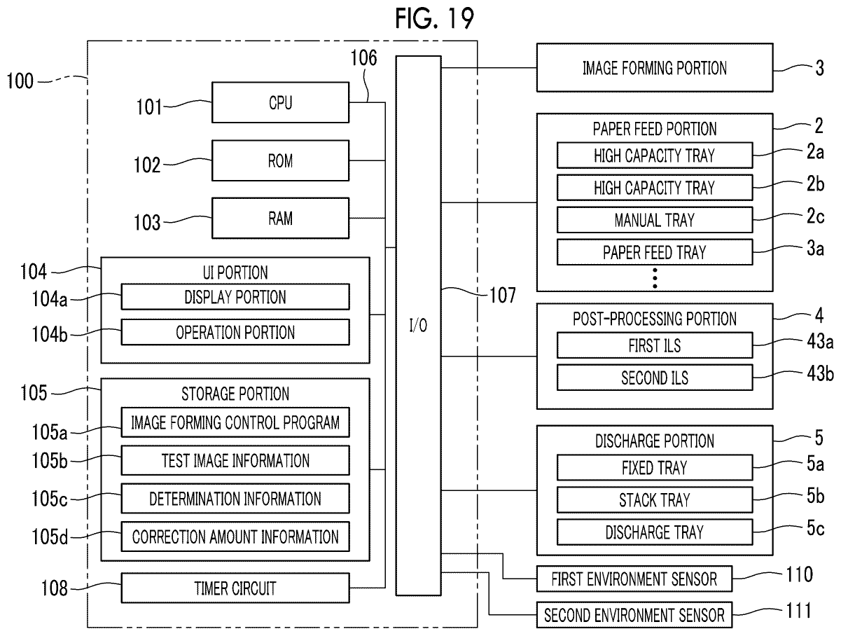

FIG. 19 is a block diagram illustrating a control device of the image forming apparatus to which the image forming program and the image forming system according to Exemplary Embodiment 2 are applied.

The first and second environment sensors 110 and 111 are connected to the CPU 101 and the like via the input/output (I/O) interface 107.

In the image forming apparatus 1, examples of the factors that cause the amount of the misregistration and the like occurring in the image formed on the front side and the rear side of the recording paper sheet 6 by the image forming portion 3 to change include environmental factors including the temperature and the humidity inside and outside the image forming apparatus, and the density information of the image in a case where the correction amount is obtained, in addition to the difference between media such as the paper type or the size of the recording paper sheet 6 and the difference between trays from which the recording paper sheet 6 is fed.

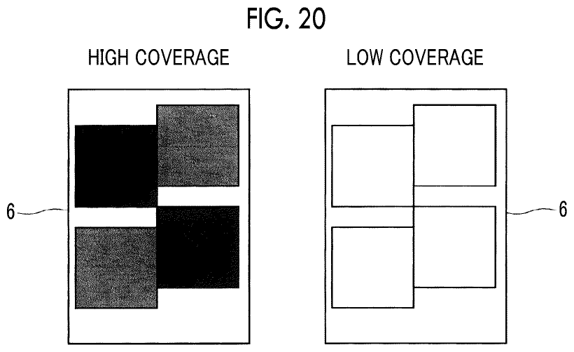

Here, as illustrated in FIG. 20, examples of the image formed by the user on both of the front and rear sides of the recording paper sheet 6 include a high coverage image in which an area occupied by a high density image is relatively large, and a low coverage image in which an area occupied by a low density image is relatively large, among images.

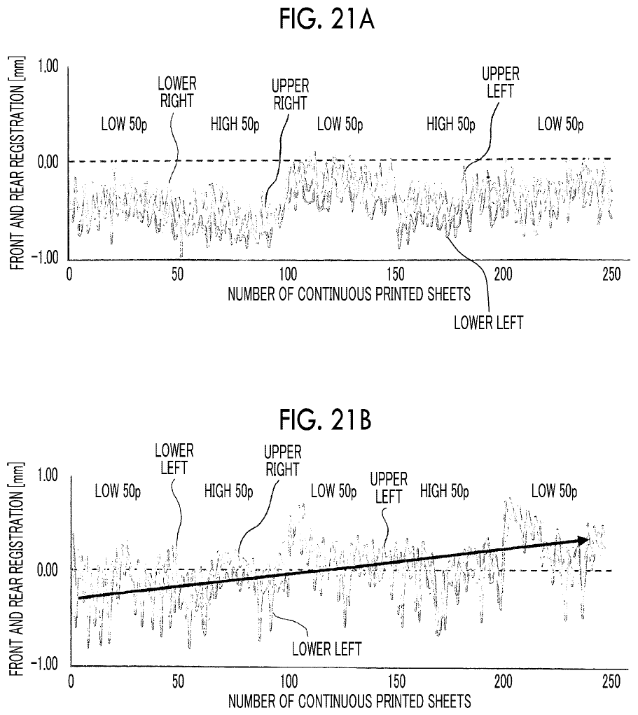

FIG. 21A is a graph illustrating a difference between the front and rear X direction misregistration read using the misregistration detection patterns 201₁ to 201₄ in a case where the image is continuously printed on J paper manufactured by FUJIFILM Business Innovation Corporation as the recording paper sheet 6 by alternately switching between the low coverage image and the high coverage image for every 50 sheets in the image forming portion 3 of the image forming apparatus 1 configured as illustrated in FIG. 3.

FIG. 21B is a graph illustrating the difference between the front and rear X direction misregistration read using the misregistration detection patterns 201₁ to 201₄ in a case where the image is continuously printed on OK Prince paper manufactured by OJI Paper Co., Ltd as the recording paper sheet 6 by alternately switching between the low coverage image and the high coverage image for every 50 sheets.

As is perceived from FIGS. 21A and 21B, a change in the difference in the X direction misregistration on the front and the rear of the recording paper sheet 6 depending on a difference in the paper type of the recording paper sheet 6 is understood. A change in the difference in the X direction misregistration between the front and the rear of the recording paper sheet 6 depending on the coverage of the image formed on the recording paper sheet 6 is also understood.

As is perceived from FIG. 21B, a tendency of an increase in the difference in the X direction misregistration on the front and the rear of the recording paper sheet 6 in accordance with an increase in the number of recording paper sheets 6 to be continuously printed is understood.

Therefore, in the image forming apparatus 1 according to Exemplary Embodiment 2, the storage portion 105 as an example of the storage unit is configured to store the correction amount in association with both of the environment information detected by the environment detection unit in a case where the correction amount is obtained, and the density information of the image in a case where the correction amount is obtained, in addition to the medium information and the supply portion information.

The image forming apparatus 1 according to Exemplary Embodiment 2 includes the prohibition unit that prohibits the user from accessing a part of the information stored in the storage portion 105.

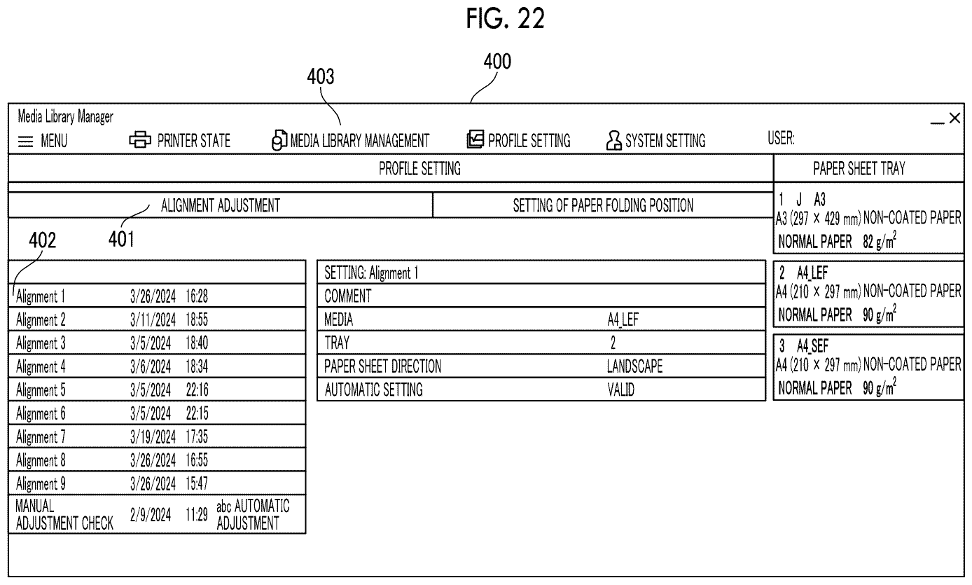

Specifically, as illustrated in FIG. 22, on the screen 400 of Media Library Manager, a customer engineer can set the deviation amount of each of the X direction misregistration, the perpendicularity deviation, the X direction magnification deviation, the Y direction misregistration, the obliqueness deviation, and the Y direction magnification deviation in the information stored in the storage portion 105 to a non-display state by operating a display portion 403 for media library management as an example of the prohibition unit.

In this case, the deviation amount of each of the X direction misregistration, the perpendicularity deviation, the X direction magnification deviation, the Y direction misregistration, the obliqueness deviation, and the Y direction magnification deviation is set to the non-display state, that is, a state that cannot be accessed by the user.

By not displaying data of the deviation amount that the user does not need to access in terms of operating the image forming apparatus 1, user interface (UI) and user experience (UX) are improved.

In the image forming apparatus 1 according to Exemplary Embodiment 2, in executing the subsequent print operation, the user sets the content of the print job using the operation portion 104b of the UI portion 104.

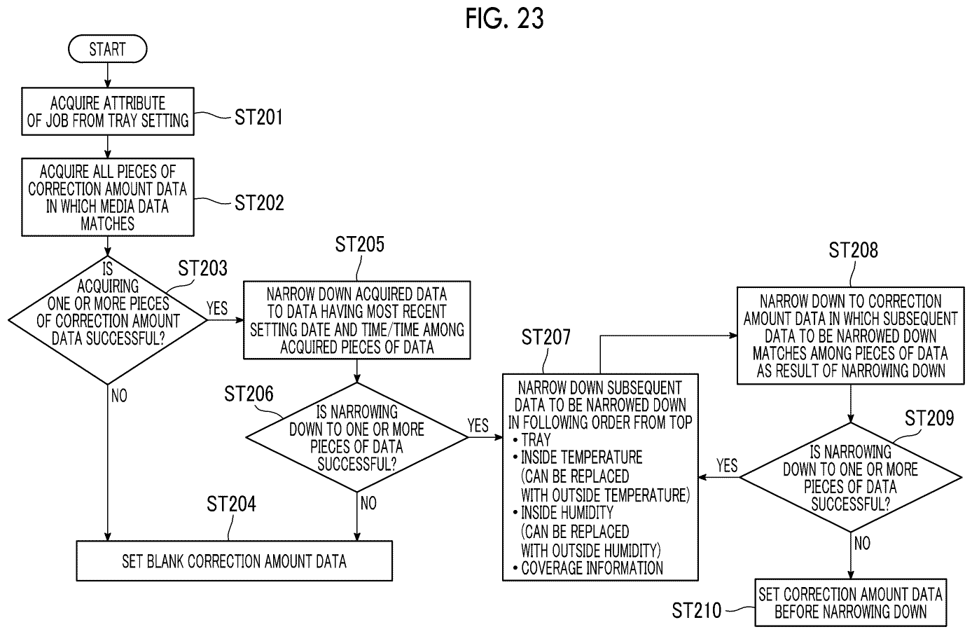

Then, as illustrated in FIG. 23, the CPU 101 acquires an attribute of the job in accordance with a job condition of each tray such as the high capacity trays 2a and 2b of the paper feed portion 2 and the paper feed trays 3b, 3c, and 3d of the image forming portion 3, in accordance with the content of the print job set using the operation portion 104b of the UI portion 104 (step S201).

Next, the CPU 101 acquires all pieces of the correction amount data in which the media data matches, from the correction amount data stored in the correction amount information 105d of the storage portion 105 (step S202). The CPU 101 determines whether or not one or more pieces of the correction amount data are acquired (step S203), and in a case where one or more pieces of the correction amount data are not acquired, determines that there is no available correction amount data and sets blank correction amount data (step S204).

In a case where the CPU 101 determines that one or more pieces of the correction amount data are acquired (step S203), the CPU 101 narrows down the acquired data to the latest data having the most recent setting date and time/time among the acquired pieces of data (step S205).

Then, the CPU 101 determines whether or not narrowing down the acquired data to one or more pieces of data having the most recent setting date and time/time among the acquired pieces of data is successful (step S206). In a case where narrowing down the acquired data to one or more pieces of data having the most recent setting date and time/time among the acquired pieces of data is not successful, the CPU 101 sets blank correction amount data (step S204).

Meanwhile, in a case where narrowing down to one or more pieces of data is successful, the CPU 101 selects an item to be narrowed down in an order of tray data→inside temperature (can be replaced with outside temperature)→inside humidity (can be replaced with outside humidity)→coverage information among the pieces of data that are successfully narrowed down (step S207).

Here, the temperature and the humidity inside and outside the image forming portion 3 of the image forming apparatus 1 and the coverage information of the image may not have matching values at all times. Therefore, the temperature and the humidity inside and outside the image forming portion 3 are classified into a plurality of regions such as high temperature and high humidity, normal temperature and normal humidity, and low temperature and low humidity, and the CPU 101 determines the same region as matching. In the same manner, the coverage information of the image is divided into a plurality of regions such as high coverage, medium coverage, and low coverage, and the same region is determined as matching.

Next, the CPU 101 performs processing of narrowing down to the correction amount data in which the subsequent data to be narrowed down matches among pieces of data as a result of narrowing down (step S208). The CPU 101 determines whether or not narrowing down to one or more pieces of data among the pieces of the correction amount data in which the subsequent data to be narrowed down matches is successful (step S209).

In a case where the CPU 101 determines that the narrowing down to one or more pieces of data is successful, the CPU 101 returns to step S207 and transitions to the item of the subsequent data to be narrowed down (step S208). The CPU 101 determines whether or not narrowing down to one or more pieces of data among the pieces of the correction amount data in which the subsequent data to be narrowed down matches is successful (step S209).

Finally, in a case where the CPU 101 determines that narrowing down to one or more pieces of data is not successful, the CPU 101 sets the correction amount data before narrowing down (step S210).

In the image forming apparatus 1 according to Exemplary Embodiment 2, in automatically setting the correction amount data stored in the storage portion 105 as the correction amount information 105d, the correction amount data can be stored and used by taking the temperature and the humidity inside and outside the image forming portion 3 and the coverage of the image affecting the misregistration of the image into consideration, in addition to the correction amount data in which the media data and the tray data match.

Thus, according to the image forming apparatus 1 according to Exemplary Embodiment 2, the correction amount data in which other factors affecting the deviation amount of the misregistration of the image match in addition to both of the media data and the tray data can be selected and applied. Accordingly, in the image forming apparatus 1, in a case where the print operation is started under the print condition set by the user using the UI portion 104, optimal correction amount data among the pieces of the correction amount data stored in the storage portion 105 can be adopted.

Other configurations and actions are the same as Exemplary Embodiment 1 and thus, will not be described.

While the exemplary embodiments describe the color image forming apparatus including four image creating devices 10Y, 10M, 10C, and 10K of yellow (Y), magenta (M), cyan (C), and black (K) as the image forming apparatus, the invention is not limited to the exemplary embodiments and can also be applied to a monochrome image forming apparatus including only an image creating device of black (K) as the image forming apparatus.

While the exemplary embodiments illustratively describe the electrophotographic image forming apparatus, the present invention may be applied to an image forming apparatus of a system other than the electrophotographic system. For example, the invention may be applied to an image forming apparatus of an ink jet system.

While the exemplary embodiments describe processing performed by executing a program stored in a storage portion, the invention is not limited to the exemplary embodiments, and the processing of the program may be implemented by hardware.

### SUPPLEMENTARY NOTE

(((1)))

An image forming apparatus comprising:
an image forming unit that forms an image on a recording medium supplied from a supply portion under a predetermined condition;
a correction unit that obtains a correction amount of the condition in accordance with a reading result of the image formed on the recording medium and corrects the condition; and
a storage unit that stores the correction amount,
wherein the storage unit stores the correction amount in association with both of medium information for specifying the recording medium and supply portion information for specifying the supply portion.
(((2)))

The image forming apparatus according to (((1))),
wherein the correction unit, in a case where the correction amount in which only the medium information matches is present among correction amounts stored in the storage unit, performs the correction using the correction amount in which the medium information matches.
(((3)))

The image forming apparatus according to (((1))),
wherein the storage unit stores the correction amount in association with date and time information at which the correction amount is stored, in addition to the medium information and the supply portion information.
(((4)))

The image forming apparatus according to (((3))),
wherein the correction unit does not use the correction amount in a case where a predetermined time elapses from the date and time information of the correction amount stored in the storage unit.
(((5)))

The image forming apparatus according to (((1))), further comprising:
an environment detection unit that detects at least one of a temperature or humidity inside and outside the image forming apparatus,
wherein the storage unit stores the correction amount in association with at least one of environment information detected by the environment detection unit in a case where the correction amount is obtained, or density information of the image in a case where the correction amount is obtained, in addition to the medium information and the supply portion information.
(((6)))

The image forming apparatus according to (((1))), further comprising:
a prohibition unit that prohibits a user from accessing a portion of information stored in the storage unit.
(((7)))

An image forming program causing a computer to function as each portion of the image forming apparatus according to any one of (((1))) to (((6))).
(((8)))

An image forming system comprising:
an image forming unit that forms an image on a recording medium supplied from a supply portion under a predetermined condition;
a correction unit that obtains a correction amount of the condition in accordance with a reading result of the image formed on the recording medium and corrects the condition;
a storage unit that stores the correction amount; and
a processor configured to:
   store the correction amount in the storage unit in association with both of medium information for specifying the recording medium and supply portion information for specifying the supply portion.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image forming unit that forms an image on a recording medium supplied from a supply portion under a predetermined condition;
a correction unit that obtains a correction amount of the condition in accordance with a reading result of the image formed on the recording medium and corrects the condition; and
a storage unit that stores the correction amount,
wherein the storage unit stores the correction amount in association with both of medium information for specifying the recording medium and supply portion information for specifying the supply portion.

2. The image forming apparatus according to claim 1,
wherein the correction unit, in a case where the correction amount in which only the medium information matches is present among correction amounts stored in the storage unit, performs the correction using the correction amount in which the medium information matches.

3. The image forming apparatus according to claim 1,
wherein the storage unit stores the correction amount in association with date and time information at which the correction amount is stored, in addition to the medium information and the supply portion information.

4. The image forming apparatus according to claim 3,
wherein the correction unit does not use the correction amount in a case where a predetermined time elapses from the date and time information of the correction amount stored in the storage unit.

5. The image forming apparatus according to claim 1, further comprising:
an environment detection unit that detects at least one of a temperature or humidity inside and outside the image forming apparatus,
wherein the storage unit stores the correction amount in association with at least one of environment information detected by the environment detection unit in a case where the correction amount is obtained, or density information of the image in a case where the correction amount is obtained, in addition to the medium information and the supply portion information.

6. The image forming apparatus according to claim 1, further comprising:
a prohibition unit that prohibits a user from accessing a portion of information stored in the storage unit.

7. A non-transitory computer readable medium storing an image forming program causing a computer to function as each portion of the image forming apparatus according to claim 1.

8. A non-transitory computer readable medium storing an image forming program causing a computer to function as each portion of the image forming apparatus according to claim 2.

9. A non-transitory computer readable medium storing an image forming program causing a computer to function as each portion of the image forming apparatus according to claim 3.

10. A non-transitory computer readable medium storing an image forming program causing a computer to function as each portion of the image forming apparatus according to claim 4.

11. A non-transitory computer readable medium storing an image forming program causing a computer to function as each portion of the image forming apparatus according to claim 5.

12. A non-transitory computer readable medium storing an image forming program causing a computer to function as each portion of the image forming apparatus according to claim 6.

13. An image forming system comprising:
an image forming unit that forms an image on a recording medium supplied from a supply portion under a predetermined condition;
a correction unit that obtains a correction amount of the condition in accordance with a reading result of the image formed on the recording medium and corrects the condition;
a storage unit that stores the correction amount; and
a processor configured to:
store the correction amount in the storage unit in association with both of medium information for specifying the recording medium and supply portion information for specifying the supply portion.

14. An image forming apparatus comprising:
image forming means for forming an image on a recording medium supplied from a supply portion under a predetermined condition;
correction means for obtaining a correction amount of the condition in accordance with a reading result of the image formed on the recording medium and correcting the condition; and
storage means for storing the correction amount,
wherein the storage means stores the correction amount in association with both of medium information for specifying the recording medium and supply portion information for specifying the supply portion.
